(19) United States
(12) Patent Application Publication
(10) Pub. No.: US 2025/0135938 A1
(43) Pub. Date: May 1, 2025

(54) SYSTEMS AND METHODS FOR ELECTRIC VEHICLE CHARGING OPTIMIZATION AND GRID BALANCING

(71) Applicant: BluWave Inc., Ottawa (CA)

(72) Inventors: Alexander LINCHIEH, Ottawa (CA); Christopher GALBRAITH, Ottawa (CA); Keegan Michael John GREEN, Ottawa (CA); Kaan Turker GUN, Ottawa (CA); Thomas TRIPLET, Ottawa (CA); Devashish PAUL, Ottawa (CA)

(21) Appl. No.: 18/613,216

(22) Filed: Mar. 22, 2024

Related U.S. Application Data
(60) Provisional application No. 63/593,566, filed on Oct. 27, 2023.

(51) Int. Cl. B60L 53/67; B60L 53/66; B60L 53/68; H02J 7/00

(52) U.S. Cl. CPC B60L 53/67; B60L 53/66; B60L 53/68; H02J 7/0071

(57) ABSTRACT

Systems and methods are provided relating to power systems, such as a power grid, including for providing control to a power system by utilizing available flexibility in charging electric vehicles (EVs). The system generates control information for controlling the power system based on predicted power demand in the system during a target time period and based on predicted EV charging curtailment information, which relates to a predicted flexibility in charging EVs while meeting charging goals of the EVs during a target time period. The generated control information includes EV charging scheduling information that utilizes the predicted flexibility in charging EVs by scheduling charging of EVs to curtail or to increase an aggregate charging load of the EVs during the target time period.

### REFERENCE TO RELATED APPLICATIONS

This application claims the benefit of priority of U.S. Provisional Patent Application No. 63/593,566 filed on Oct. 27, 2023, which is incorporated herein by reference.

### FIELD

The present disclosure relates to power systems, such as a power grid, including to controlling a power system by utilizing available flexibility in charging electric vehicles (EVs).

### BACKGROUND

With the rise of electric vehicle (EV) adoption in smart grids, different entities, such as utility and distribution companies, grid system operators, EV fleet operators, EV manufacturers, EV charger original equipment manufacturers (OEMs), charger network operators, and private individuals, are attempting to develop new ways to coordinate EV charging, including in smart grids. A smart grid may generally refer to an electrical grid or other electricity network that may use digital and other advanced technologies to manage the transportation of electricity from generation sources to meet the fluctuating electricity demands of end users. A smart grid may comprise smart distribution boards, renewable energy resources, energy efficient resources, and advanced metering infrastructure.

Improvements in technologies relating to the control of power systems that include charging of EVs are desired. Improvements in technologies relating to EV charging control are also desired.

The above information is presented as background information only to assist with an understanding of the present disclosure. No assertion or admission is made as to whether any of the above, or anything else in the present disclosure, unless explicitly stated, might be applicable as prior art with regard to the present disclosure.

### BRIEF DESCRIPTION OF DRAWINGS

Example embodiments of the present disclosure will now be described with reference to the attached Figures.

FIG. 1 is a diagram of an example power system.

FIG. 2 is a block diagram of an example power control system for providing control to a power system.

FIG. 3 is a diagram showing example functional layers, information sources, and communication paths according to an example power control system.

FIGS. 4A-4C are diagrams of examples illustrating different techniques for scheduling charging and discharging of an EV.

FIGS. 5-7, which are diagrams of examples illustrating different techniques for scheduling charging for 5 EVs.

FIG. 8 is a diagram showing example functional layers and information sources which includes a mechanism for filling-in some missing data.

FIG. 9 is a diagram showing example functional layers and information sources which includes a more general mechanism for filling-in missing data or information.

FIG. 10 is a diagram showing components or modules of an example subsystem for filling-in missing data or other information.

FIG. 11 is a process flow diagram of an example method relating to providing control to a power system which includes EVs.

FIG. 12 is a block diagram of an example computerized device or system.

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

### DETAILED DESCRIPTION

The present disclosure generally relates to improvements in computer-based technologies relating to electricity power system management and control. In an aspect, controlling a power system may comprise, for example, performing power supply-demand balancing in the power system or performing power peak shifting or shaving in the power system, where the controlling utilizes available flexibility in charging individual EVs in the power system to intelligently schedule charging of the EVs to improve the control of the power system. The scheduling of EV charging may include selectively curtailing or increasing an aggregate charging load of the EVs to improve supply-demand balancing or peak shifting/shaving in the power system In an aspect, the present disclosure relates to improvements in computer-based technologies relating to generating and providing control in relation to the charging EVs in a power system. In an aspect, the present disclosure relates to improvements in EV charging management and control technologies.

Furthermore, in prior systems for balancing electrical supply and demand in a power system, the flexibility in balancing the supply and demand is typically limited through use of existing Energy Storage System (ESS) technologies such as a Battery Energy Storage System (BESS), pumped hydroelectricity, flywheels, and so on. For example the use of ESSs to store energy when demand is low or supply is high, and to discharge ESSs when demand is high or supply is low. This may apply to the contexts of the growing adoption of renewable energy, and the growing adoption of EVs. A lack of supply-demand balancing may be considered a two-part problem of insufficient supply at times of excess demand. ESSs can be used for supply-demand balancing, potentially solving both problems at once, but ESSs are of limited power or energy capacity, and may be discouragingly expensive to purchase, install, and maintain. Indirectly, this may hinder certain generation schedules, generation sources, or types of generation sources from being used or adopted over others. To illustrate, consider that renewable sources of electricity are often affected by weather and time of day and are thus intermittent, while a gas-fired plant can have a constant generation capacity year-round and at any time of day. A solar farm may generate a surplus at midday, but this surplus and potential to reduce greenhouse gas emissions goes to waste unless the extra energy is stored, such as in an ESS, or unless the demand was made higher to meet the surplus. On the other hand, demand might be in excess in evenings because many residential EV users arrive home then and start charging their depleted EVs. To meet this demand, the existing supply may be supplemented by the gas-fired plant, resulting in greenhouse gas emissions. Such emissions may be avoided by reducing the demand or by discharging an ESS charged by the solar farm at midday. However, emissions may not be avoided in such a way if the required capacity of ESS is prohibitively expensive. In addition or alternatively, the power system may be required to curtail power usage during a defined period.

In peak shaving, the maximum power allowed to flow through electrical infrastructure of a power system is limited, such as for the purpose of prolonging the lifetime of the infrastructure and reducing its need of repair or replacement. This can apply especially to the context of the growing adoption of EVs, whose aggregate charging load poses a threat to the infrastructure of a power system. As the number of EVs grows, the aggregate charging load on a power system also grows. This includes an instantaneous aggregate charging load of EVs, meaning the total EV charging load at any point in time. Electrical infrastructure includes electrical transformers, power lines, etc. As described for balancing supply and demand, ESSs can similarly be used to do peak shaving but it may be prohibitively expensive. Furthermore, while a single ESS of sufficient power and energy capacity may be used to do peak shaving at a higher level in the power system (for example local level) and thus protect the electrical infrastructure at that level, this does not necessarily protect the lower level (for example neighborhood level) infrastructure. Doing so may require multiple, smaller ESSs at the neighborhood level, which may be undesirable.

In some prior approaches, the charging of EVs is tied to a specific charging network, or to a particular EV charging manufacturer or EV manufacturer. In addition, some prior approaches are tied to a specific hardware vendor or to a specific charge network operator. This can create a lack of interoperability with other equipment in a power system. These limitations may limit or prevent higher level EV charging control at the power system.

A power system generally refers to any system that delivers power from a source to a recipient and can include but is not limited to a power grid. Power systems of any sizes and types are contemplated. The terms “power grid” and “grid” are often used herein and they refer generally to any kind of power system unless a different meaning is explicitly provided or is implied.

As the number of EVs grows, the impact and demand of the charging of EVs on the power grid also grows. This creates some issues, for example spikes in the load in the grid caused by spikes in EV charging as a result of mass simultaneous EV charging. This can lead to a need for additional peak load capacity, for example by providing further peak power generation, in the grid and/or power curtailment in the grid. In addition, the timing of some of this charging may be difficult to predict, making it difficult for grid operators to balance the grid supply with the grid demand. Additionally, the load of EV charging in the grid increases the overall load in the grid, which can create or increase spikes in the grid, which can stress the power grid infrastructure, resulting in shorter lifetimes of certain components such as transformers and increasing maintenance and replacement costs.

The present disclosure provides systems and methods that address some of these issues, for example by intelligently scheduling charging of EVs in the grid to reduce demand on the grid caused by EV charging during certain time periods, for example periods of high demand in the grid. This reduction in EV charging demand can potentially reduce a need for additional peak load capacity in the grid, for example by reducing the amount of peak power generation needed, and lower the stress on the grid infrastructure. In an aspect, EVs in the power grid are treated essentially as a distributed, virtual ESS (hereinafter “virtual ESS”), where the charging, and possibly discharging, of which can be scheduled in an intelligent way to improve an optimization in the power system, for example power supply-demand balancing or peak shaving or shifting. Thus, this use of EVs as a virtual ESS may provide new or enhanced flexibilities in providing control to the grid. In addition, other types of controllable energy storage assets in the power grid other than EVs, such as but not limited to ESSs, may also be used as part of a virtual ESS.

Energy storage technologies, such as BESSs, pumped hydro energy storage systems, and so on, are generally limited by power capacity, energy capacity, size, availability, and/or cost. In comparison, using EVs in a power grid collectively as a virtual ESS may overcome some shortcomings of energy storage technologies in power grids.

For example, the storage of an electricity system may typically be up to 20-40 GWh, being able to provide power for a duration in the range of hours and only being able to do so again when recharged. For instance, the energy storage capacity of a region such as a province or state, such as Ontario, may be approximately 3-4 GWh, and is able to deliver 230 MW of power. This is typically a small fraction of load of the region. In comparison, in an example of one million EVs in a one city, these EVs arriving home and charging by up to 50 kWh at approximately the same time each evening presents the opportunity to use 50 GWh of their collective energy storage for alleviating their effect on the grid by intelligently scheduling their charging, for example postponing or reducing their charging. A disadvantageous alternative to this would be discharging an expensive utility-scale energy storage system by only 20-40 GWh, only to have to recharge it in preparation for the next day's arrival of at least one million EVs. Furthermore, utility-scale energy storage systems generally do not scale naturally with the population of the service area, whereas the number of EVs generally and naturally increases with the population and with increasing EV adoption.

Currently, no systems with current energy storage technology provide this amount of effective energy storage, whether they attempt to do so by utilizing, for example, larger batteries, or by intelligently managing their utilization. In contrast, the present disclosure provides systems and methods for controlling power systems and for controlling EV charging that utilize the collective effective energy storage of EVs, thereby approaching an energy capacity that may be used to at alleviate the effect of charging all of these EVs on the grid, among other purposes.

Intelligently scheduling the charging of EVs may involve predicting future power demand in the power grid, which may include identifying one or more periods of predicted higher power demand and/or lower power demand. The charging of EVs may be scheduled by taking advantage of the flexibility in charging EVs while meeting charging goals of the EVs.

A charging goal of an EV may be a target departure time, which can also include a date, and a specified target state of charge (SoC) of the EV battery. Charging goal information may be specified by an EV user or specified or determined in any other manner, for example by a control or optimization system according to the present disclosure. For instance, the system may set target parameters relating to charging for one or more EVs, for example to further improve an optimization or for any other reason. For example, a user may return home and plug in their EV on Monday evening at 6 pm and specify that they want their EV charged up to 75% SoC by 9 am the next morning (meaning Tuesday). Between now and tomorrow at 9 am, there may be more than enough time to charge this EV to 75%. For example, it may take a total of 6 hours to charge up the EV to 75% SoC from its current lower SoC. However, there are 15 hours between 6 pm and the indicated time of departure of 9 am. So, there is flexibility on when and how to charge the EV during this 15 hour period. In addition, there may be flexibility on the charging rate(s) to use for charging. For instance the EV could be charged at the maximum supported charging rate, or it could be charged at a lower rate, for example 50% or 75% of a maximum supported charging rate, while still getting to at least 75% SoC by 9 am tomorrow.

In general, EVs are not available for charging when they are not coupled to a power source, for example a power grid. This is often referred to herein as being unplugged. Similarly, EVs may be or are available for charging when they are coupled to a power source, which is often referred to herein as being plugged in. When an EV becomes available for charging is sometimes generally referred to herein as when an EV “arrives”, for example when an EV arrives at a depot and so on, and such times are sometimes referred to as “arrival times”. Similarly, when an EV becomes unavailable for charging is sometimes generally referred to herein as when an EV “departs”, for example when an EV departs a depot and so on, and such times are sometimes referred to as “departure times”. The same applies to prediction information relating to arrivals or departures of EVs.

A system and method according to the present disclosure may use this flexibility in EV charging of multiple EVs when scheduling the charging of these EVs. This may be used to provide control over an aggregate EV charging load of EVs in the power grid. This may be used, for example, to reduce and smooth out spikes in EV charging load that would have otherwise occurred without the intelligent charging scheduling. A reduction in a demand spike caused by EV charging will generally in turn reduce an overall demand in the power grid, which can be used to avoid grid overloading, avoid or reduce a need for temporarily or permanently increasing supply to the grid, avoid or reduce a need for power curtailment in the grid, and so on.

In some aspects, a system according to the present disclosure may be referred to as a power control system, for providing control to a power system. For example, a power control system may provide control, which may be based on optimizations, to provide power supply-demand balancing optimization or power peak shaving/shifting optimization in a power system. According to the present disclosure, the control may include intelligently controlling charging of EVs and possibly other assets such as ESSs in the power system to improve the performance of an optimization, for example for supply-demand balancing or peak shifting or shaving.

In addition, a system according to the present disclosure may predict the ability of EVs to have their charging curtailed or increased, for example at a future time. This is generally referred to as charging curtailment prediction information. Charging curtailment prediction information may be used to intelligently schedule charging of multiple EVs in the power grid. When scheduling EV charging, the actual abilities of at least some EVs to have their charging curtailed may be unknown. Similarly, a collective charging curtailment ability of EVs in the grid is likely unknown. This includes the likelihood of not knowing the actual number of EVs that will be plugged into the grid at a future time (meaning number of EVs available for charging) since an EV that will not be plugged into the grid will not be a candidate for charging curtailment. Thus, the charging curtailment prediction information may allow for more intelligent EV charging scheduling, which in turn may allow for more intelligent control of a power grid, for example by being able to perform more efficient or accurate optimizations for supply-demand balancing or peak shifting/shaving in the grid. The EV charging control information may be provided to one or more computing devices for providing charging control to the EVs. Such a computing device may be at any suitable location, for example at an EV charge point or at the EV itself.

In some embodiments, the charging curtailment prediction information may include prediction information relating to an aggregate amount of EV charging load curtailment that will be available at some future time period(s). An aggregate amount of EV curtailment may refer to a statistical characterization of a collective ability to use EVs for curtailing load during the time period. For example, this may be based on a predicted number of EVs that will be plugged in the future time period, meaning coupled to the power grid and thus available for charging, and their flexibilities in having at least some of their charging scheduled at a time that is outside of the future time period. In another aspect, a system may make predications relating to an aggregate amount of EV charging load increase that will be available at some future time period, which may be used to increase an overall load in a power system, for example during a period of low demand or high supply. Such prediction information may be based on, for example, on a predicted number of EVs that will be available for charging (e.g. plugged in) during the future time period, meaning coupled to the power grid, and their flexibilities in having at least some of their charging scheduled during the future time period. A prediction relating to an aggregate amount of EV charging load curtailment or increase that will be available at some future time periods may be used by a power control system in performing some control on the power system, for example but not limited to supply-demand balancing or peak shifting/shaving. For example, the power control system may make different decisions for peak shaving for an upcoming predicted peak in demand if is has a prediction that there will be a high amount of EV charging load that can likely be curtailed during the upcoming predicted peak than the power control system would have otherwise made.

In an aspect, EV charging may be controlled to control an aggregate charging load of the EVs in the power system, meaning the combined total charging load of the EVs. Controlling the aggregate charging load of the plurality of EVs, for example by controlling the charging of individual EVs, can provide an ability to at least partly control an overall load or power demand in the power system. This may be used to, for example, reduce the overall power demand in the power system during a time period when the power demand in the power system is high, for example during a peak power demand period. The overall power demand in the power system may be reduced during this peak period by reducing the aggregate EV charging load during period. Similarly, controlling the aggregate charging load of EVs may be used to, for example, increase the overall power demand in the power system during a time period when the power demand in the power system is low or when there is excess supply.

A reduction in the aggregate EV charging load during a time period may be achieved by, for example, performing at least some charging of at least some of the EVs outside of the time period, or by charging at least some of the EVs at a lower charging rate during the time period, or a combination of both. The time period may be a peak demand period. Similarly, an increase in the aggregate EV charging load during a time period may be achieved by, for example, performing at least some charging of at least some of the EVs within the time period, or by charging at least some of the EVs at a higher charging rate during the time period, or a combination of both.

As mentioned above, the present disclosure provides systems and methods relating to controlling a power system and controlling EV charging of EVs by using EVs essentially as virtual ESSs. The ESS may be considered virtual since it is not one physical ESS but instead is made up of many separate batteries of EVs. The ESS may be considered distributed since the EVs and their individual batteries are likely spread out over a geographical region. In an aspect, the present disclosure employs EVs in essence as a large virtual ESS, which may, for example, improve one or more of power supply and demand balancing, and peak shaving or shifting in a power system. The optimization may be system wide, generally meaning that the optimization is done at a top level of the system and thus may be used to optimize the charging of EVs in the whole power system as opposed to just a subset of the power system or a subset of the EVs.

In some embodiments, the present disclosure provides a system for providing control to a plurality of EVs that goes beyond a very basic level such as control by charging network operators. In at least some embodiments, the present systems provide a more holistic solution that takes into account requirements of, for example, one or more of a grid operator, a utility, and grid assets by the coordination of EV charging hardware, particularly for EVs (such as electric cars) used by customers of the grid.

In some embodiments, the present disclosure provides a system that goes well beyond basic EV charging management of single EVs, for example at a residential consumer level, for example via smartphone apps. These apps may allow the user to link their EV charging hardware to the app, and have some sort of basic control based on, for example, time-of-use pricing. However, such solutions lack integration with the larger power system, such as a utility or distribution grid, and thus cannot enable a holistic EV charging solution that provides power system level control and optimization. Likewise, some EV manufacturers also provide a smartphone app that allows the user to enter basic schedules for their charging.

In some embodiments, the present disclosure provides a system that takes into account some or all of the following example considerations in relation to intelligently managing EV charging, including for residential customers and EV users: grid operator data, such as bottlenecks in the grid, live electrical supply and demand, and electrical marketplace signals; utility and distribution company data, such as bottlenecks in the distribution grid from electrical demand and power flow; utility-scale renewable energy generation, for example from solar farms and wind turbines; residential scale behind-the-meter solar or other renewable generation; EV user preferences such as their target time of departure (by which time it is desired that their EV is charged to a certain amount); demand response signals from the grid operator; EV telemetry (state of charge (SoC), mileage, power consumption, and so on); and/or EV charger telemetry (EV charging transactions, power consumption, and so on).

According to an aspect, the present disclosure is directed to a system, comprising: a computer-readable storage medium having executable instructions; and one or more computer processors configured to execute the instructions to provide control in relation to a power system having a plurality of electric vehicles (EVs), wherein the EVs are chargeable with power from the power system, the instructions to: receive power system information, the power system information including power demand prediction information relating to predicted demand for power in the power system, the power demand prediction information covering a target time period; receive charging curtailment prediction information relating to the EVs, the charging curtailment prediction information relating to a predicted flexibility in charging EVs while meeting charging goals of the EVs, the charging curtailment prediction information covering the target time period; generate power system control information for controlling the power system based on the power system information and the charging curtailment prediction information, the power system control information including EV charging scheduling information for use in charging the EVs, the EV charging scheduling information utilizing the predicted flexibility in charging EVs by scheduling charging of EVs to curtail or to increase an aggregate charging load of the EVs during the target time period; and control the power system based on the power system control information, including providing the EV charging scheduling information to one or more computing devices for providing charging control to at least some of the EVs.

In an embodiment, the controlling the power system based on the power system control information comprises performing at least one of: power supply-demand balancing in the power system, and power peak shaving or peak shifting in the power system, and wherein the controlling the power system is based on the EV charging scheduling information.

In an embodiment, the target time period includes a predicted upcoming period of higher power demand in the power system, and wherein the EV charging scheduling information includes scheduling of charging of EVs outside of the target time period to curtail the aggregate charging load of the EVs during the target time period.

In an embodiment, the charging curtailment prediction information comprises information relating to at least one of: a prediction of an aggregate number of EVs that will be available during the target time period to have their charging curtailed; and a prediction of an aggregate amount of EV charging load that will be available during the target time period to be curtailed.

In an embodiment, the instructions are further to: generate the charging curtailment prediction information based on at least one of: historical information comprising at least one of: an aggregate number of EVs that were available during a time period to have their charging curtailed; an aggregate amount of EV charging load that was available during a time period to be curtailed; EV charging goal information of EVs comprising at least one of: target charging completion date and time information for a given EV, and target EV battery state of charge (SoC) information; and EV charging and use information comprising EV departure date and time information for a given EV, and EV battery state of charge (SoC) information at the time of the EV departure, and at least one of weather information and traffic information.

In an embodiment, the charging goals of the EVs comprises at least one of: target charging completion date and time information, and target EV battery state of charge (SoC) information at target charging completion.

In an embodiment, the power system control information comprises separate control information for each of at least two subsets of the power system, and wherein the controlling the power system comprises separately controlling each of the at least two subsets of the power system.

In an embodiment, at least one of: the scheduling charging of at least some of the EVs outside of the target time period comprises scheduling no charging of the at least some of the EVs during the predicted upcoming period of higher power demand; and the EV charging scheduling information utilizes the predicted flexibility in charging EVs by scheduling charging of individual EVs of at least some of the EVs during the target time period at a curtailed charging rate that is lower than a charging rate that is available to a respective individual EV during the target time period.

According to an aspect, the present disclosure is directed to method comprising: at one or more electronic devices each having one or more processors and computer-readable memory, to provide control in relation to a power system having a plurality of electric vehicles (EVs), wherein the EVs are chargeable with power from the power system: receiving power system information, the power system information including power demand prediction information relating to predicted demand for power in the power system, the power demand prediction information covering a target time period; receiving charging curtailment prediction information relating to the EVs, the charging curtailment prediction information relating to a predicted flexibility in charging EVs while meeting charging goals of the EVs, the charging curtailment prediction information covering the target time period; generating power system control information for controlling the power system based on the power system information and the charging curtailment prediction information, the power system control information including EV charging scheduling information for use in charging the EVs, the EV charging scheduling information utilizing the predicted flexibility in charging EVs by scheduling charging of EVs to curtail or to increase an aggregate charging load of the EVs during the target time period; and controlling the power system based on the power system control information, including providing the EV charging scheduling information to one or more computing devices for providing charging control to at least some of the EVs.

In an embodiment, the controlling the power system based on the power system control information comprises performing at least one of: power supply-demand balancing in the power system, and power peak shaving or peak shifting in the power system, and wherein the controlling the power system is based on the EV charging scheduling information.

In an embodiment, the target time period includes a predicted upcoming period of higher power demand in the power system, and wherein the EV charging scheduling information includes scheduling of charging of EVs outside of the target time period to curtail the aggregate charging load of the EVs during the target time period.

In an embodiment, the charging curtailment prediction information comprises information relating to at least one of: a prediction of an aggregate number of EVs that will be available during the target time period to have their charging curtailed; and a prediction of an aggregate amount of EV charging load that will be available during the target time period to be curtailed.

In an embodiment, the method further comprises: generating the charging curtailment prediction information based on at least one of: historical information comprising at least one of: an aggregate number of EVs that were available during a time period to have their charging curtailed; an aggregate amount of EV charging load that was available during a time period to be curtailed; EV charging goal information of EVs comprising at least one of: target charging completion date and time information for a given EV, and target EV battery state of charge (SoC) information; and EV charging and use information comprising EV departure date and time information for a given EV, and EV battery state of charge (SoC) information at the time of the EV departure, and at least one of weather information and traffic information.

In an embodiment, the charging goals of the EVs comprises at least one of: target charging completion date and time information, and target EV battery state of charge (SoC) information at target charging completion.

In an embodiment, the power system control information comprises separate control information for each of at least two subsets of the power system, and wherein the controlling the power system comprises separately controlling each of the at least two subsets of the power system.

In an embodiment, at least one of: the scheduling charging of at least some of the EVs outside of the target time period comprises scheduling no charging of the at least some of the EVs during the predicted upcoming period of higher power demand; and the EV charging scheduling information utilizes the predicted flexibility in charging EVs by scheduling charging of individual EVs of at least some of the EVs during the target time period at a curtailed charging rate that is lower than a charging rate that is available to a respective individual EV during the target time period.

According to an aspect, the present disclosure is directed to non-transitory computer-readable medium having computer-readable instructions stored thereon, the computer-readable instructions executable by at least one processor to cause the performance of operations relating to providing control in relation to a power system having a plurality of electric vehicles (EVs), wherein the EVs are chargeable with power from the power system, the operations comprising: receiving power system information, the power system information including power demand prediction information relating to predicted demand for power in the power system, the power demand prediction information covering a target time period; receiving charging curtailment prediction information relating to the EVs, the charging curtailment prediction information relating to a predicted flexibility in charging EVs while meeting charging goals of the EVs, the charging curtailment prediction information covering the target time period; generating power system control information for controlling the power system based on the power system information and the charging curtailment prediction information, the power system control information including EV charging scheduling information for use in charging the EVs, the EV charging scheduling information utilizing the predicted flexibility in charging EVs by scheduling charging of EVs to curtail or to increase an aggregate charging load of the EVs during the target time period; and controlling the power system based on the power system control information, including providing the EV charging scheduling information to one or more computing devices for providing charging control to at least some of the EVs.

In an embodiment, the controlling the power system based on the power system control information comprises performing at least one of: power supply-demand balancing in the power system, and power peak shaving or peak shifting in the power system, and wherein the controlling the power system is based on the EV charging scheduling information.

In an embodiment, the target time period includes a predicted upcoming period of higher power demand in the power system, and wherein the EV charging scheduling information includes scheduling of charging of EVs outside of the target time period to curtail the aggregate charging load of the EVs during the target time period.

In an embodiment, the charging curtailment prediction information comprises information relating to at least one of: a prediction of an aggregate number of EVs that will be available during the target time period to have their charging curtailed; and a prediction of an aggregate amount of EV charging load that will be available during the target time period to be curtailed.

In an embodiment, the charging curtailment prediction information covers a secondary target time period, and wherein the EV charging scheduling information includes scheduling of charging of EVs within the secondary target time period to increase the aggregate charging load of the EVs during the secondary target time period.

In an embodiment, the secondary target time period includes a predicted upcoming period of surplus power supply in the power system.

In an embodiment, the target time period includes a predicted upcoming period of surplus power supply in the power system, and wherein the EV charging scheduling information includes scheduling of charging of EVs within of the target time period to increase the aggregate charging load of the EVs during the target time period.

The foregoing summary provides some example aspects and features according to the present disclosure. It is not intended to be limiting in any way. For example, the summary is not necessarily meant to identify important or crucial features of the disclosure. Rather, it is merely meant to introduce some concepts according to the disclosure. Other aspects and features of the present disclosure are apparent to those ordinarily skilled in the art upon review of the following description of specific example embodiments in conjunction with the accompanying figures.

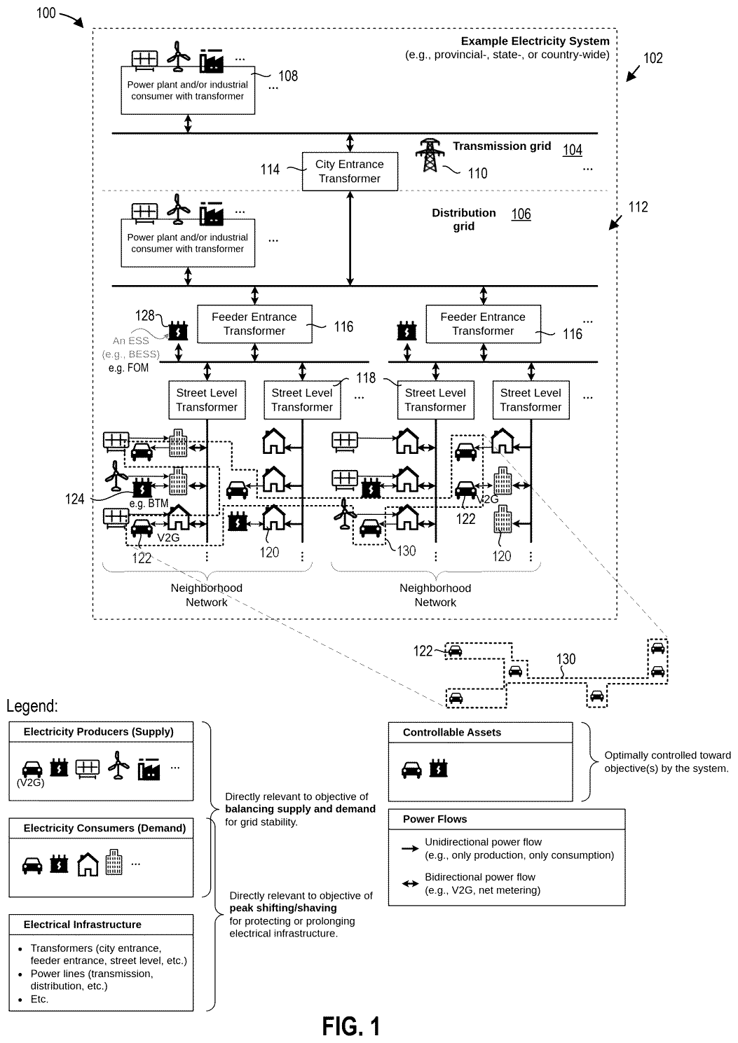

FIG. 1 is a diagram of an example power system 100. A power system as used herein generally refers to any system that involves the distribution of power, including electrical power. A power system 100 may include a power grid 102, which may include a network for transmission and distribution from one or more power sources to end customers. In addition, a power system may refer to a part of a power grid, a large power system, a small power system, and so on. However, in general, the terms power system and power grid are used interchangeably herein. Furthermore, a power system generally refers to any power network or system, and is thus not limited to a conventional power grid. A power subsystem may be subdivided into several subsystems or subsets or subregions.

Power grid 102 may comprise sub grids, for example a power transmission grid 104 and a power distribution grid 106. A power grid generally comprises one or more power generating plants 108, power transmission infrastructure 110 to carry power long distances, and power distribution infrastructure 112 to deliver power to end customers. Power generating plants 108 may include any types of power generation, such as fossil fuel such as coal or gas, nuclear, and renewables such as solar, wind, and so on. Power distribution infrastructure 112 may include one or more substations or entrance transformers 114, for example for stepping down the voltage from the transmission infrastructure to a lower voltage for the distribution infrastructure. In addition, there may be power generation systems 108 within power distribution grid 106. Power distribution infrastructure 112 may include one or more feeder transformers 116 and one or more distribution transformers 118 which may further step down the voltage from the feeder transformers 116 to a lower voltage, for example for delivery to end customers 120.

EVs 122 may be associated with the customers 120. Customers 120 may be associated with any type(s) of power consumer, for example a home or other building or dwelling, a charging station, a charge point, an EV, an ESS such as a batter energy storage system (BESS) 124, and so on. Such ESSs may be behind the meter (BTM) devices. Customers 120 may include any other class of metered energy consumption point connected to the grid. In addition, there may be one or more sources of power generation 126 downstream in the distribution grid 106, for example renewable power sources at or connected to one or more of the homes or other buildings or premises of customers 120. Such power may be temporarily stored in ESSs 124.

Power system 100 may generally include any types of energy sources, including a discharging ESS, and a discharging EV with vehicle-to capabilities, such as vehicle-to-everything (V2X) capabilities. V2X may include vehicle-to-grid (V2G).

Power system 100 may include a tree like structure, such as distribution grid 106, which may be thought of as having multiple different branches, for example from a substation to various feeders, or from a feeder to various transformers, and so on.

FIG. 1 includes a legend, the contents of which are only examples and are thus not limiting or comprehensive.

The systems, methods, and so on according to the present disclosure may be used with any types of suitable power systems. For example, in an embodiment, a system according to the present disclosure may be implemented and used with a level similar to that of an overall electricity system, for example, at a similar level to Ontario's IESO (Independent Electricity System Operator) or the CAISO (California Independent System Operator). In addition, a system may be used with a distribution utility or within an individual network of a local electrical grid, or at any other level or combination of levels. In at least some embodiments, a system may be suitably applied to a higher-level electricity system rather than a distribution utility which is within the “last mile” of distributing power to consumers.

Traditionally, power flows from top to bottom in an electricity system, starting from generating stations or power plants connected to the transmission grid or directly to a local distribution grid, then typically flowing through a city entrance transformer to be delivered to industrial consumers and via feeder entrance and street level transformers to commercial and residential consumers. More and more frequently, industrial, commercial, and residential consumers are setting up microgrids and/or net metering to be considered as electricity producers as well (for example with solar, wind, ESSs, and V2X). Furthermore, ESSs may be implemented alongside pieces of electrical infrastructure (for example feeder entrance transformers, as shown above) to do peak shifting/shaving, thereby protecting or prolonging the grid infrastructure. Examples of such ESSs 128 are shown in FIG. 1, which may front of meter (FOM) ESSs.

Some example optimizations by a controller according to the present disclosure are now described. In some embodiments, optimizations relating to EV charging may be performed as though the EVs are essentially a virtual ESS. In FIG. 1, a dashed line 130 encircling all the EVs 122 represents an example of the concept of a distributed, virtual ESS made up of or comprising the EVs 122. In other embodiments, a virtual ESS may comprise other controllable energy storage assets, such as one or more ESSs 124, 128 in the power system 100.

An effective aggregation of EVs as one energy storage device as a virtual ESS may differ from a regular front-of-the-meter and behind-the-meter ESSs in multiple ways. Thus, a virtual ESS may not necessarily be controlled or used using the same approaches.

For example, since the EVs are likely distributed throughout the service area such as a power grid, the virtual ESS is also distributed. This includes an energy capacity, energy level, and charging and discharging power limits of the virtual ESS. This means that a virtual ESS may be able to take into account electrical demand, distributed energy resource (DER) generation, demand response signals, or grid infrastructure including line capacities at a potentially higher resolution throughout the service area, such as at the neighborhood level. This may be in contrast to a regular ESS which is typically implemented at a specific node in the grid.

Furthermore, a virtual ESS differs from a regular ESS, for example, because its properties such as energy capacity and power limits change over time, for example depending on how many EVs are plugged-in at the time, what their individual battery energy capacities are, what their individual power limits are, what their required future SoC for use is, and so on. This may also mean that, even at a particular instance of time, a virtual ESS may not or cannot be treated as a regular ESS because its power limits vary depending on which EVs are charged/discharged and which EVs are able to be charged/discharged. The availabilities of the EVs, meaning which EVs are plugged-in and able to be curtailed or discharged at any given time, may be predicted. The availabilities may be affected in part by road dynamics, which may be predicted as part of predicting the availabilities of EVs.

Additionally, depending on the development and adoption of V2G- and V2X-compatible EVs and EV charging equipment, the discharge power limit of a virtual ESS may be severely limited. However, this does not necessarily mean that a virtual ESS cannot be used for demand response as it would be charging by default and can be turned off in part to do demand response.

An optimization performed by the system may use the plugged-in EVs, which are electrically coupled to the power system, in essence as a large virtual ESS. An optimization problem may be single or multi objective and does is not necessarily formulated or solved as a mathematical optimization problem. Furthermore, the optimization may employ AI techniques, such as machine learning (ML), such as reinforcement learning (RL). Any of the objectives may be formulated at the level of the overall power system, and possibly at a finer resolution(s) or simply at a smaller scale, for example as within individual networks of a local electrical grid.

A electricity system such as power system 100 represents a variety of assets and opportunities to optimally control some of the assets, particularly given the increasing prevalence of EVs and ESSs. However, such optimization and control is typically subject to the constraints imposed by other entities such as power system operators, assets such as transmission and distribution power lines, transformers of various sizes, utility and distribution company assets, commercial EVs and EV charging hardware, and other pieces of electrical infrastructure. Additionally, the optimization and control of the power system or assets associated with the power system may be limited, for example by the availability of a given EV's ability for charging, charging curtailment, or discharge at a given point or period in time. A power system typically attempts to balance its total supply to match its total demand as best as possible. In addition, a power system may generally attempt to perform this balancing in a way that attempts to protect and prolong the life of its electrical infrastructure.

Optimizations may be performed in relation to a given level in a power system, for example at a level of a street level transformer within a neighborhood network, up to a system-wide implementation meaning at the top level of the power system. Thus, the term “system-wide” generally refers to doing something at the top level of a system. An optimization may effectively consider EVs, and potentially ESSs, as controllable assets and may essentially consider the EVs as a virtual ESS. In addition, other optimization objectives are possible and contemplated.

The resolution of system's inputs, outputs, and constraints to a power control system may be arbitrary. For example, if implemented for an overall power system, inputs such as electricity demand and constraints such as limits on the electricity demand may be broken down at the level of individual networks in the transmission or distribution grids, or may be aggregated. However, in at least some embodiments, more granular resolutions may generally be better.

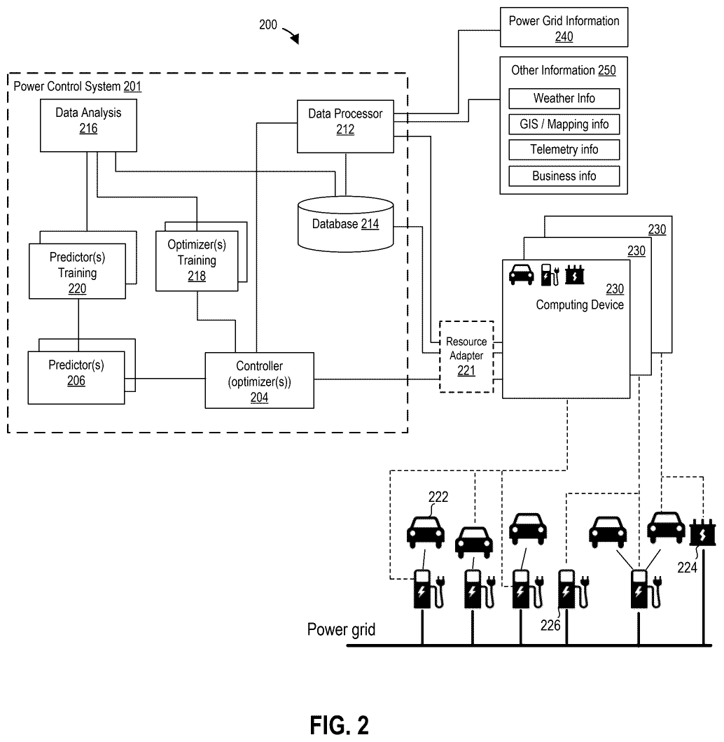

FIG. 2 is a block diagram of an example power control system 200 for providing control to a power system such as system 100 of FIG. 1. The control may include performing supply-demand balancing or peak shifting/shaving in the power system or any other suitable control in relation to the power system. In addition, the control may include control to assets, for example EVs 222, ESSs 224, charge points 226, that can charge from a power system such as the system of FIG. 1. The assets are electrically coupled to or can be coupled to the power system or grid to receive power from the power system. Charging system 200 may be used to provide charging control to assets in a system such as system 100 in FIG. 1, for example to schedule EV charging to for instance improve supply-demand in the power system, to improve peak shaving, or to improve peak or load shifting in the power system.

Charging system 200 may comprise a power control system 201, which may receive various types of information from various sources. The data or other information may be historical data, streaming or live data, predicted data or information. For example, power control system 201 may receive information 240 relating to the power grid, such as but not limited to current and historical power demand and power supply, transformer or substation data, voltage levels, current loads, power flows, error codes, load demand, grid congestion, advanced/smart metering infrastructure (AMI) or any other types of suitable information from or relating to the power grid. In addition, power control system 201 may receive information 250, such as weather related data and/or geo data, geographic information system (GIS) or mapping information, telemetry information, business information, or any other suitable information. This information may be generally referred to as environment data, although other types of information may also be included. Further, other types of environment data may include, for example, information on renewable energy generation and availability, energy grid operational parameters, electric vehicle and/or vehicle depot information, actual EV charging demand, predicted EV charging demand, energy market information, route manager information relating to vehicles, renewable energy information, energy cost information, or any other suitable type of information.

Further, power control system 201 may receive information from assets in a power system or power grid, such as from EVs 222, EV charge points or chargers 226, ESSs 224 such as BESSs, and so on. This may be any type of suitable data or information available at or from the assets, including any of the various types of information described herein. This may include EV charging goals, EV telematics information, other EV data such as battery SoC, battery state of health (SoH), EV mileage, EV user preferences and habits, on-site power generation information, ESS information, and so on. In an embodiment, at least some of the information may be streaming data, real time data, and/or live data.

Data processor 212 may perform data cleaning, data warehousing or other operations on received data. Data received by data processor 212 may be cleaned, conditioned, or otherwise modified. Data processor module 212 may transform data into a format more suitable for machine learning techniques, such as supervised learning. Data from data processor 212 may be provided to another module(s), such as database 214 or controller 204.

Data and other information may be stored in one or more repository databases, for example database 114. The stored data may include historical data and so on. A database may comprise one or more databases stored on one or more computing devices.

Data, for example from database 214, may be provided to data analysis module 216. Data analysis module 216 may be configured to perform one or more of data processing and feature selection, for example for the purposes of preparing training data for use by a predictor training module 220 or optimizer training module 218.

Predictor training module 220 may train one or more predictors 206. Optimizer training module 218 may train an optimizer for controller 204. The training data used for the training may comprise historical data.

One or more predictors 206 may be used for predicting information, such as power grid power demand, EV charging demand, EV charging load curtailment prediction information, EV charging load increase prediction information, EV SoC, energy cost, weather information, traffic information, on-site power generation, and so on. A predictor may predict SoC of the batteries of EVs, for example based on historical information such as EV charging patterns, EV user behavior, and inference based on time of week, time of day, and time of year, and so on.

Predicted information may be provided to controller 204. Prediction information may be generated for a predefined time horizon or window. A time horizon may represent for how far in the future, and possibly at what frequency, prediction information is generated for. As a mere example, prediction information may be generated for the next hour, 24 hours, 48 hours, one week and so, at an resolution of 30 minutes, 1 hour, 4 hours, 12 hours, and so on. For instance, predicted power demand in a power system may be predicted for the next 7 days and may include predictions for power demand in time windows of 4 hours in the 7 day horizon.

Controller 204 may have one or more optimizers and may be used to perform optimizations, such as those described herein, for example providing control to a power system, for instance by performing supply-demand balancing or peak shaving or shifting, or providing charging control to EVs 222 and possibly other assets. Control information may be generated for a predefined time horizon or window. A time horizon may represent for how far in the future, and possibly at what frequency, the control information is generated for. As a mere example, control information may be generated for the next hour, 24 hours, 48 hours, one week and so, at an resolution of 30 minutes, 1 hour, 4 hours, 12 hours, and so on. For instance, control information may be generated for the next 7 days and may include control information for each 4 hour period within the 7 day horizon.

Input to controller 204 may include any suitable information, for example power system information, which may include any types of information relating to the power system, for example relating to power demand in the power system. Demand information may include current power demand and/or power demand prediction information relating to predicted demand for power in the power system. The power demand prediction information may cover a target time period in the future, for example in one or more future time periods. Other potential input to controller 204 may include charging curtailment prediction information relating to EVs.

Controlling EV charging may be done in part, for example, via one or more of intelligent prediction of quantities including renewable energy generation, power demand in the power system, and power demand based on EV charging. The method may use intelligent optimization of ESSs and EV charging. In addition, a system according to the present disclosure may take into account grid operator parameters such as real time power demand, load profiles, demand response signals, generation capacity, power purchase agreements, power system infrastructure, line capacities, energy market and congestion prices, and market participant data.

Output of controller 204 may comprise power system control information for providing control to the power system. Controller 204 may generate a signal providing or indicating the power system control information and the signal may be communicated to EVs and potentially to other assets and/or the signal may be provided to one or more computing devices 230 for providing control to the EVs. The power system control information may generally include control actions for the power system, which may relate to supply-demand balancing or peak shaving or shifting. In addition, charging control for EVs may be in the form of EV charging scheduling information, which may be provided to EVs 222 and possibly other assets such as charge points 226 or ESSs 224. The EV charging scheduling information may utilize the predicted flexibility in charging EVs by scheduling charging of EVs to curtail or to increase an aggregate charging load of the EVs during a target time period.

The EV charging scheduling information may include charging related actions, such as commanding specific EVs when to begin charging, when to stop charging, time periods during which to charge and not charge, a charging rate (for example charging current) to be used for charging, a specific charging point(s) that may be used, a charging schedule, which source(s) of power to use to charge EVs, if or when or how to use energy stored in some EVs to charge other EVs, and so on. In addition, the EV charging scheduling information may include control information such as actions for other assets such as ESSs 224, for example instructions relating to when to start charging/discharging, when to stop charging/discharging, a charging/discharging rate (e.g. current), and so on.

The power system control information may be provided to one or more computing devices 230 for providing control to the power system, which may include charging control to the EVs 222 and so on. A computing device 230 may be part of a computing system for controlling the power system. In regard to EV charging scheduling, a computing device 130 may be a device of an EV itself, a device onboard an EV, a device of a charging point or station 226, a device communicatively coupled to an EV or charge point, an intermediary device, and so on.

In an embodiment, system 200 may comprise a resource adapter 221 which may provide an interface, for example to enable or facilitate communications, between the power control system 201 and computing devices 230 and/or assets such as EVs, ESSs 224, charge points 226. While resource adapter 221 is shown outside of the dashed line of the power control system 201, this is not meant to be limiting.

A resource adapter 221 may be configurable and a specific resource adapter may allow power control system 201 to receive information from a specific class of asset or from a specific source of information, for example other info 250, and send information, such as control information from controller 204 for controlling one or more controllable assets. This may provide power control system 201 with interoperability with different classes of assets, such as EVs of different manufacturers, or types of assets such as EVs, charge points, BESS, and so on. A controllable asset may utilize its specific communication protocol, and a resource adapter 221 may serve as intermediaries that facilitate direct communication between power control system 201 and the assets. By acting as bridges, resource adapters may play a role in connecting the system with new resources, granting access, and enabling control. The flexibility of resource adapters may allow for seamless integration or removal without disrupting the core services offered by the system. Consequently, the system may be able to swiftly adapt to changing environments and requirements by implementing new resource adapters to incorporate additional controllable assets.

For example, a specific resource adapter may be used to communicate directly with EVs of a specific make and model, indirectly with such EVs through their manufacturer's proprietary service, or indirectly with EVs of mixed make and model through an API service. As further examples, there may be specific resource adapters for a specific make and model of charge point, for example communicating via Open Charge Point Protocol (OCPP), or for a specific make and model of BESS, for example communicating via Message Queuing Telemetry Transport (MQTT). Furthermore, resource adapters may be used to interface with system inputs and outputs in general, not solely assets. In general, resource adapters do not need to be automated, electrical, or computerized.

The objectives of optimizations performed by present systems and methods may be any suitable objectives. Example objectives may relate to one or more of power supply and demand balancing in a power system, peak or load shifting or shaving in a power system, and so on. Other objectives may include or relate to minimizing a peak of an aggregate EV charging load during a time period, minimizing total aggregate EV charging load during a time period, maximizing total aggregate EV charging load during a time period, reaching some threshold for total aggregate EV charging load during a time period, and so on. Decision variables associated with an objective may relate to the scheduling of charging of EVs, for example charging start and stop dates and times, and charging rates. An optimization may optimize for one or more objectives by scheduling charging for the plurality of EVs while taking into account the charging flexibility of the EVs.

Example objectives of supply-demand balancing and peak shaving are now described.

In supply-demand balancing in a power system, the electrical supply generally refers to power generation, discharging batteries or other ESSs into the power grid, and so on. Demand generally refers to total load in the power grid, such as an electrical load of a building, batteries charging up from the grid, and so on.

In a power grid, using systems according to the present disclosure, it may be possible to achieve a total supply in the grid that may closely match total demand, which provides grid stability. The balancing of supply and demand may be achieved using a present system despite that portions of the supply and demand may not be controllable by the present system. For example, the present system may not be able to control a generation by a power plant, a load of a building, and so on. However, the present system is able to provide control to other assets in the power grid, for example by providing some control to EV charging. In addition, ESSs may also be used.

Balancing supply and demand may be done by controlling charging of EVs to shift some of the demand from one point or period in time to another point or period in time. This may be done, for example, by one or more of postponing or otherwise scheduling charging until a time of higher supply, or by charging earlier rather than at a later time of lower supply. In such a case, the demand is supply-driven. In an optimization where an objective is balancing supply and demand of power in the system, inputs may include one or more of current power demand, predicted power demand, current power supply, and predicted power supply. In addition, another input may be charging curtailment prediction information relating to EVs in the power system.

In a case of EV charging with V2X capabilities, the electrical supply may be driven by the demand and matching the supply and demand may additionally or alternatively be done by shifting the supply in time to meet the demand. This may be done by, for example, charging EVs at times of lower demand such that they may be discharged back into the grid at times of higher demand by the system. As such, EVs may even be discharged to charge other EVs depending on differences in their constraints. Supply-demand balancing is described in this embodiment as an optimization objective rather than as a constraint in the sense that any undesirable measures to balance supply and demand are minimized.

In supply-demand balancing, the optimization objective would be to influence the demand-side (via EV charging) such that the difference between electrical supply and demand is kept to a minimum.

In addition, an optimization for power supply-demand balancing may enable a selection of certain power generation schedules, generation sources, or types of generation sources to be used or adopted instead of others. For example, a power control system may attempt to reduce greenhouse gas emissions by shifting extra demand produced by EV charging to earlier in the day, when a solar farm produces an extra supply of electricity. Furthermore, a power control system may use EVs with V2X (vehicle-to-everything) discharge capabilities such as V2G (vehicle-to-grid) as an ESS to store surplus power from the solar farm for a higher demand period later in the day, which higher demand may have otherwise been fulfilled by a gas-fired plant.

Peak shaving and peak shifting may refer to minimizing peaks in a load over time, keeping the load below a given threshold, reducing the load by a given amount, and so on. Peak shaving may be done indirectly for a purpose of supply-demand balancing, such as imposed by a distribution utility's power bill, peak shaving here may refer to a purpose of protecting or prolonging electrical infrastructure of the power system. Peak shaving using an optimizer according to the present system may be accomplished in a similar manner to supply-demand balancing, for example as if there is an upper bound on the electrical supply and the demand may ideally closely match it. The system may schedule EV charging to avoid charging or reduce charging of EVs when doing so would contribute to a peak. Where an optimization objective includes peak shifting/shaving, inputs to the optimization may include one or more of current power demand in the power system, predicted power demand in the power system, and electrical infrastructure information of the power system.

In a case of EV charging with V2X capabilities, the system may schedule charging of such EVs when doing so would not contribute to a peak such that they may be discharged by the system, at another time, to reduce or eliminate a peak at that time. Peak shaving may inherently include valley filling, wherein the energy displaced/shifted away from creating peaks may be intentionally consumed during times of otherwise minimal load, thereby “evening out” the resulting load over time.

Some example optimization constraints are now discussed. Optimizations performed by an optimizer of a controller according to a present charging system may be subject to constraints, such as charging goals of the EVs which may include EV users needing their EVs to be charged to a target SoC by a target departure time, which may be a preferred time of departure. Constraints may be treated as hard or soft constraints in an optimization problem. Qualitative and quantitative information describing the constraints may be provided to the system, for example EV user preferences may be provided by a smartphone app. Constraints for battery health such as keeping its SoC within a certain range may be applied, especially with V2X. Examples of other constraints include limits to the power that may be allowed to flow through different circuits at different levels in the electrical infrastructure of the power system, such as for safety or to protect or prolong the life of the electrical infrastructure.

A power control system and its controller/optimizer may use predictions relating to a current time until a certain horizon in the future. Wherever a predication of a piece of information is required, a current value of that piece of information may also be required. Firstly, a prediction of EVs' availability may be used. This prediction information may relate to when each EV is expected to be available for charging or not (e.g. plugged in or unplugged), a minimum amount of energy that is to be delivered to each EV, and, optionally, which currently unplugged EVs will become plugged-in and when. Furthermore, doing supply-demand balancing or peak shaving, for example in ways described herein, may use predictions of both supply and demand, or solely the demand, which may correspond to a load predictor. These predictions may comprise time series data. In general, a prediction may be based on another prediction. For example, if wind and solar generation contributes to the electrical supply, then wind and solar predictions may be used and predictions of wind speed, wind direction, solar irradiance, and cloud cover may be used as intermediate inputs. As another example, a predictor of EVs' availability may use information relating to a traffic model or predictor, since traffic can affect the EV's availability. A traffic predictor may in turn use predictions of weather, which can affect traffic.

Furthermore, as with the examples of supply-demand balancing and peak shaving, the predictions of supply and demand may apply to an overall power grid and/or such predictions may be more granular, for example, relating to one or more subsets or subregions of the power grid. In general, predictions do not necessarily need to be perfect. Rather, predictors may need only to be sufficiently accurate and sufficiently complex. If a predictor has insufficient or different prediction horizons, for example 20 hours ahead compared to 24 hours ahead, then missing prediction information may be inferred or extrapolated, for example forward-filled, to a minimum horizon used by the power control system. Predictions generated and/or used by the system may include prediction intervals or other features to similar effect, for example predicting that a value will be between lower and upper bounds within 95% certainty rather than merely forecasting one “best” or “most likely” value(s).

One or more predictors 206 of a power control system may generate predictions relating to charging curtailment abilities of a group of EVs as a collective, for example all EVs in the power grid that are or are expected to be available for curtailment. A predictor may be configured to make predictions of, for example, an aggregate number of EVs that will be plugged-in, plugged-in and charging, or available for their charging load to be curtailed (or temporarily increased). Such a prediction may be at least partly based on historical information, such as a typical or average number of plugged in EVs on a specific day of the week at a specific time. A predictor may be configured to make predictions of an aggregate amount of EV charging load that can be curtailed or increased and/or an aggregate amount of EV charging load that can be curtailed or increased at some time(s) in the future. A prediction of an aggregate amount of EV charging load that can be curtailed/increased may similarly be at least partly based on historical information, such as an aggregated ability or flexibility for charging of these EVs during a time period to be curtailed or increased during the time period. These types of predictions may constitute a statistical characterization of a collective ability to use EVs for curtailing or increasing load at given times, which may aid objectives such as supply-demand balancing or peak shaving.

Such predictions may be based historical information such as on previously observed numbers of EVs in a status of interest, the battery capacities or power limits of known EVs, and historical or current user preferences such as charging goals. For example, if the day ahead is a Saturday, then it may be assumed for prediction purposes that the same number of EVs will be plugged-in at similar times and with similar charging goals to a previous Saturday. In addition, predictions EVs' collective ability to have their charging load curtailed or increased may be based on other information or factors, for example weather forecasts or traffic patterns, which may affect EV use and availability such as the number of EVs that plug in, when they plug in, and how much they need to charge. For example, if snowy weather is forecasted in an area, then it can be expected that fewer electric cars will be on the roads and thus in need of charging. However, the EVs that do go on the roads are subject to the weather and traffic conditions. These EVs may depart earlier, arrive later, and need or want additional charging due to more timely commuting due to poor weather or use of the EVs' electric heaters in cold weather.

Predictions relating to an ability of EVs to have their collective load curtailed or increased may account for how the number of EVs are expected to change over time due to increasing (or decreasing) EV adoption, demographics or population changes. For instance, there could initially be a smaller number of EVs under control. So, this would not likely make a big difference in influencing supply and demand. Although, the number of EVs and an ability to use them to influence the supply and demand may be expected to grow over time. In addition, future predictions and optimizations may need to take into consideration the influence on supply demand provided by the controlling of EVs. For example, predictions may provide information that may be helpful in assessing whether future power demands, abilities to perform supply-demand balancing, abilities to perform peak shaving, and so on, will be satisfiable and to what extent. Such predictions may be helpful to, for example, utilities companies and power distribution companies, among others. As an example, consider a geographical area for which cold weather is forecasted. The load in the power grid in the area may increase as residents have electric heaters in their homes, potentially increasing strain on the power grid and possibly calling for the load to be reduced to match the electrical supply. A reduction in the overall load in the power grid may be at least partly reduced by scheduling at least some EV charging outside of this period of high load. The EV charging scheduling may benefit from predictions of an ability of EVs to have their collective load curtailed or increased which may be impacted by weather and/or traffic conditions. In addition, such predictions may benefit from swarm algorithms.

In some embodiments, optimizations according to the present disclosure such as relating to EV charging scheduling may be done according to a receding-horizon optimization scheme. At any point in time, an optimization may make decisions for each controllable asset over the course of a horizon, which may be based on current and/or forecasted electrical supply (for supply-demand balancing), electrical demand, and/or availability of EVs. Here, controllable assets may refer to plugged-in EVs and optionally one or more regular ESSs. The decisions for the current time until the next instance of time will be taken as the actions performed by the system at the current time. In this way, the optimization is able to plan ahead based on ‘best’ available information about what will happen in the future. However, as the “next instance of time” becomes the new “current time”, the optimization may be performed again as part of a receding horizon optimization scheme, thereby taking advantage of more accurate forecasts that have since been made, and of information that became observed rather than forecasted. The iterative process may repeat indefinitely, thereby making use of the ‘best’ available information at the time while only taking actions for the time period between iterations.

An example is now provided of an optimization using a receding-horizon scheme. The optimization may be used by a present system with an objective of supply-demand balancing. The example considers a solar farm and arriving EVs arriving back to charge points in the evening. The current time is 12 pm noon, when the solar farm is generating a power surplus relative to the current demand of EV charging and other loads. Based on a model of daily patterns, solar irradiance, cloud cover, and precipitation, it is predicted that the solar farm will generate much less power in the evening. This is obvious, but specific amounts may matter, especially with inconsistent weather or a multi-day forecast horizon. The city load in itself is also predicted to be different in the evening, but, in particular, it is predicted that many EVs will be plugged-in and in need of charging, for example based on a model of daily patterns, weather, and traffic. Poor weather may have prolonged traffic, while increasing drivers' use of their EVs' electric heaters for that time, and resulting in EVs arriving home later than the day before and needing greater recharging. The system's optimization at noon may plan to charge EVs that are currently plugged-in sooner rather than later, to take advantage of the current surplus of solar generation. This applies especially to any V2X-enabled EVs, which may be discharged later. The optimization may also plan to charge ESSs if present, to discharge later on. After taking those current actions, consider a later time, and a later optimization performed by the system, in the evening, for which there is now a ‘clearer picture’ compared to previous predictions. Prediction horizons may not be shifted to start at the current time. Previous EVs being charged, the optimization may focus on charging the evening-arriving EVs using the solar surplus by discharging ESSs and V2X-enabled EVs, thereby once again contributing to the balancing of supply and demand as well as possibly avoiding the need to use a gas-fired plant.

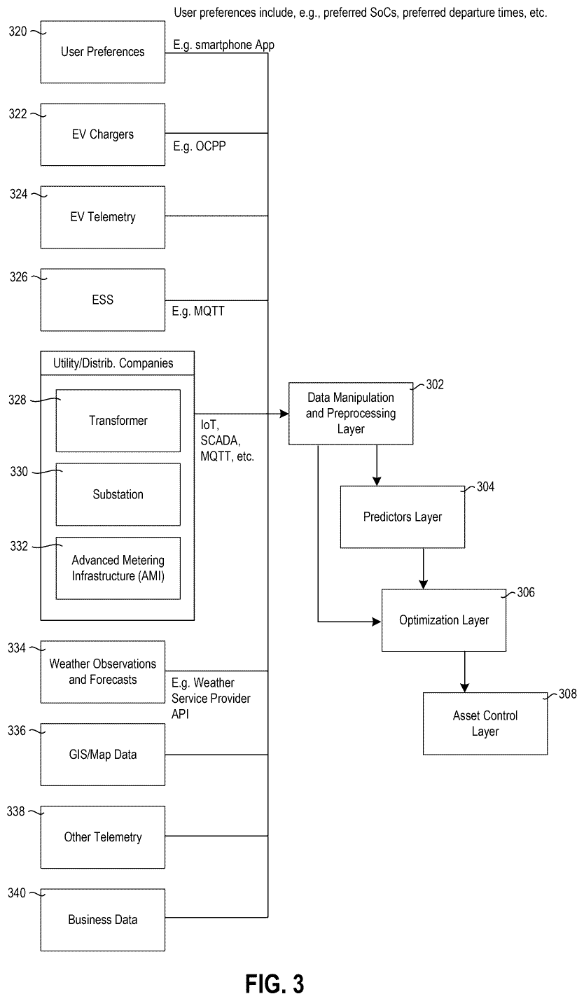

FIG. 3 is a diagram showing example functional layers, information sources, and communication paths according to an example power control system. The example functional layers include a data manipulation and preprocessing layer 302, a predictors layer 304, an optimization or control layer 306, and an asset control layer 308. This layers may relate to some of the modules or subsystems of FIG. 2, such as data processor module 212 and/or data analysis module 216, predictors module 206 and/or predictor training module 220, and controller module 204 and/or optimizer training module 218.

As shown in FIG. 3, various components may communicate with each other and receive data through any suitable communication channels such as OCPP, the MQTT network protocol, and IoT and supervisory control and data acquisition (SCADA) protocols in general.

The components include “layers” for data manipulation and preprocessing, for models such as predictors, for optimization, and for controlling assets according to an optimization. Succeeding layers may use the data provided by preceding layers. The predictors layer 304 may use raw data or preprocessed data from a previous layer such as layer 302 and/or may use information from any other sources, the optimization layer 306 may use predictions or other inferred quantities from the predictors layer 304 or data from previous layers, and so on. In some embodiments, the predictors layer 304 may be optional and may be provided to make predictions of any suitable parameters.

In an embodiment, the predictors layer 304 may be substituted by a market-based price signal produced at a wholesale power market. An actual projected market demand as well as the pre-dispatch energy pricing bids (produced by the ISOs) may be a good indicator of market conditions. Such data points may directly be used to perform peak shaving and/or load shedding. In the case of V2X, aggregated EVs can be used effectively as a single grid integrated ESS. Thus, the market data may be used to run the optimization and potentially take advantage of the arbitrage opportunities.

Example sources or types of information to power control system include a user preferences 320 or other inputted information, for example relating to EVs, such as a target time of departure, which can also include a date, and a specified target state of charge (SoC) of the EV battery. In addition, information may be obtained from or relate to EV chargers 322, EV telemetry 324, ESSs 326, power grid or system information such as utility or distribution company information for example from or relating to transformers 328, substations 330, advanced metering infrastructure (AMI) 332. Moreover, information may be obtained from or relate to weather observations and weather forecasts, mapping information and geographic information system (GIS) information 336, other telemetry information 338 which may include data other than EV telemetry 324 information for example telemetry information of non-EV vehicles or vehicles not associated with the given power grid, and business related data 340 which may include any suitable information such as relating to pricing, customer data, usage data, and so on.

The following Table 1 also provides examples of potential types of information that may be received at the power control system as well as examples of information sources.

TABLE 1

| Information Source | Description (examples) |
|---|---|
| EV Chargers | Charging station ID, location, hardware specification, power |
| | capacity, charging transaction data (transaction start/stop |
| | time, power consumed, charging rates, error codes). |
| EV Telemetry (via on board | EV identification (vehicle identification number (VIN), license |
| diagnostics (OBD), wireless | plate, username, etc.), battery SoC, charging status, location, |
| communications (e.g. LTE | odometer readings, driving behavior, vehicle attributes. |
| connection), Manufacturer | |
| API) | |
| ESSs | Energy level (e.g., BESS SoC), power capacity, charging and |
| | discharge rates, operation status, error codes. |
| Utility and Distribution | Transformer and substation data, voltage levels, current |
| Company Assets | loads, power flow, error codes, load demand, grid congestion, |
| | advanced/smart metering infrastructure (AMI). |
| Date and Time | Date and time, seasonal information (public holidays, |
| | indicators for different seasons, etc.). |
| Weather observations and | Short term: Temperature, precipitation, wind speed, humidity, |
| forecasts | atmospheric conditions. |
| | Medium and long term: climate conditions, seasonal |
| | variations, and extreme weather events. |
| Public mapping data | Data from GIS (geographic information system) sources, or |
| | google maps. Includes roads, traffic conditions, charging |
| | station locations, topology and elevation, etc. |
| Grid operation data | Real time electrical demand, load profiles, demand response |
| | signals, generation capacity, power purchase agreements, |
| | grid infrastructure, line capacities, energy market and |
| | congestion prices, market participant data. |

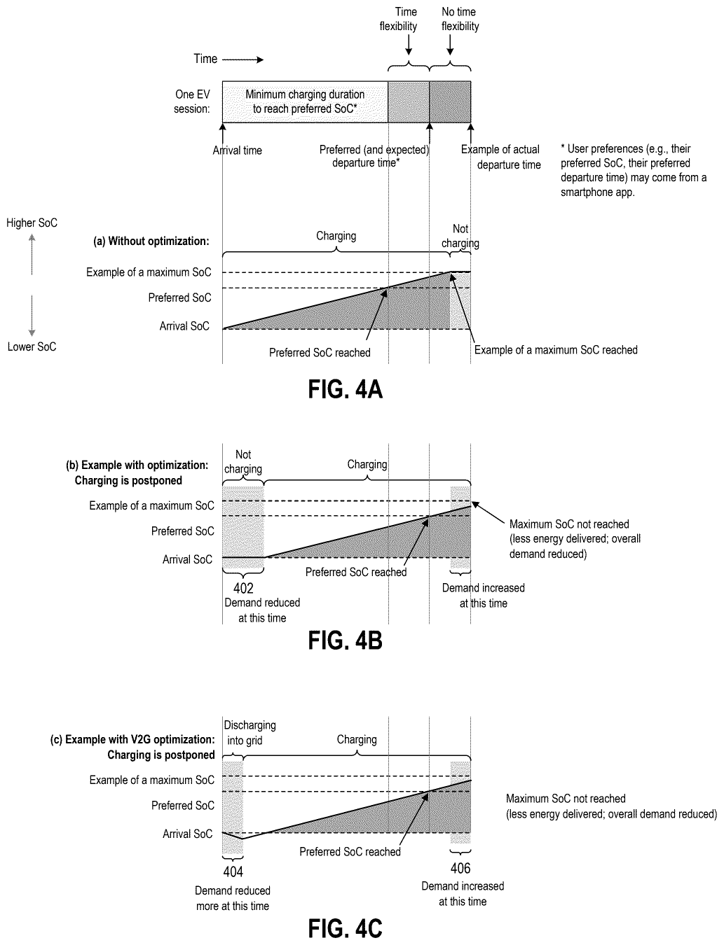

Reference is now made to FIGS. 4A-4C, which are example diagrams illustrating some example EV charging sessions. The diagrams show some constraints imposed by EV user preferences, which are charging goals of EVs, and some example parameters such as an arrival date and time and an arrival SoC of an EV. The constraints include a target SoC, which is typically the minimum SoC to which the EV should be charged, and a target departure date and time of the EV from the charge point. The arrival date and time and arrival SoC of the EV relate to the status of the EV when it arrives at or is physically connected to a charge point. This information may be obtained by the charging system in any suitable way, including via wired or wireless communications between the EV and the charge point or in any other way. A period between when an EV arrives, meaning when it is plugged in to a charge point, and when the EV departs or is scheduled to depart, and during which charging occurs, may generally referred to as a charging session.

In three cases with or without optimization, the diagrams show how a SoC of an EV increases and how the contribution of the EV to demand in the power grid over time can be shifted in time or reduced, for example for a purpose of balancing supply and demand, or peak shaving. Notably, and contrary to what is depicted in the diagram, there may be a lot of time flexibility between when a target SoC is reached and a target departure time, as is commonly seen in residential charging. The present system may utilize this flexibility of many EVs in the system, which could include hundreds, or thousands or more EVs, in an attempt to flatten out peaks or to otherwise reduce increases in the load in the power grid that would have otherwise occurred without taking advantage of this flexibility.

FIGS. 4A-4C are diagrams of examples illustrating different techniques for scheduling charging and discharging of an EV. As shown in FIG. 4A, the charging of an EV not being controlled by an optimization according to the present disclosure likely charges as soon as it is plugged-in to a charge point and continues charging until it departs or reaches a maximum SoC.

With an optimization or other control according to the present disclosure, shown in FIG. 4B, however, the EV charging is scheduled such that charging is postponed or delayed during an initial period 402 after the EV is plugged in. The not charging during period 402 reduces the demand or load in the power grid. This may be replicated for many EVs that want to charge from the grid to produce a significant reduction or shifting of load in the grid during a period of time. In addition, due to this delay, the EV does not charge to a maximum SoC during the charging session and thus results in an overall lower load put on the power grid by this charging session, as shown.

With the optimization shown FIG. 4C, which has V2X capabilities, the demand is reduced during an initial time period 404. If there are many identical or similar EV charging sessions, as an example, and one or more of the following scenarios are expected or predicted before the optimization, meaning the scheduling of charging for EVs, for instance in one or more future time periods, then the optimization shown may be able to better meet the objectives of supply-demand balancing or peak shaving: (a) there is high or excess demand in the power grid or a low or insufficient supply that is predicted to occur during the time period 404, or (b) there is a high or excess of supply that is predicted to occur during the second indicted time period 406. In any given scenario, the optimization may be performed for the given objective(s), which may include for example balancing supply-demand or peak shaving/shifting.

The charging of multiple EVs, for example multiple EV charging sessions, may be controlled to help achieve more significant objectives, for example, reducing a large demand predicted in the future. In addition, the controlling may help achieve more distributed objectives, for example, reducing different portions of demand in different parts of a power grid such as neighborhoods of residential EV charging to protect neighborhood transformers. Furthermore, finer control of EV charging, for example which EVs charge or discharge and when, or finer control over charging rates (meaning charging power) used for charging various EVs, may enable the optimization to address demand excess or supply deficiencies with finer precision since such signals typically fluctuate over time as opposed to controlling charging with a binary control in which charging is either on or off.

However, it is likely that different EV sessions will be scheduled and will occur at different dates and times and with different target SoCs. Thus, an optimization may be able to control EV charging among multiple EVs that have different time flexibilities and at different times in a coordinated manner to optimize for the given objective(s).

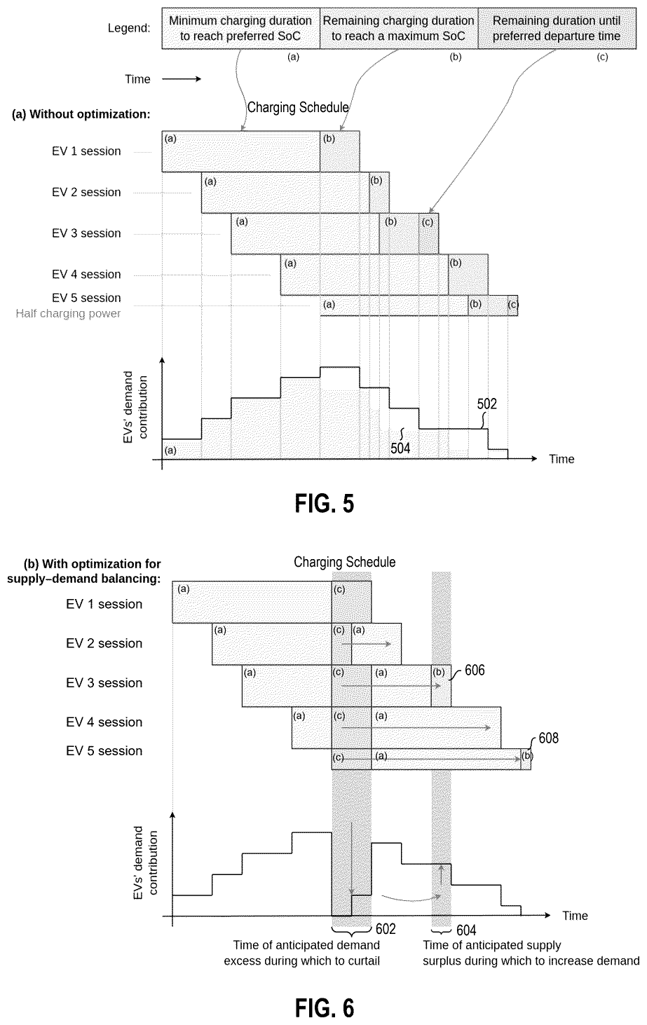

Reference is now made to FIGS. 5-7, which are diagrams of examples illustrating different techniques for scheduling charging for 5 EVs, which are labelled in FIG. 5 as EV charging sessions (“EV×session”). The diagrams show various attributes of the EVs, including their arrival dates and times, the minimum charging durations to reach the target SoCs (labelled “(a)” in some diagrams), remaining charging durations to reach maximum SoCs (labelled “(b)” in some diagrams), and remaining durations until target departure times (labelled “(c)” in some diagrams).

A charging control optimization that is performed at a given time may be limited to what is known at that time and what is predicted in the future at that time. Thus, a target departure time may be treated as the actual departure time. EV 5 session is depicted as charging at a reduced rate, meaning charging rate, available compared to the other sessions. In a real-world implementation, there may be fewer or far more than five EVs that can be plugged-in at the same time. In a large application, there would likely be many more than give EVs.

Each of FIGS. 5-7 shows a charging schedule and a corresponding plot of electrical demand of the EV charging over time. This demand is the EV charging contribution to the overall demand in the power grid. This demand is solely that of the EVs and does not include that of other electricity consumers in the power grid. The concepts shown are readily extendable to utilize V2X capabilities.

FIG. 5 shows charging scheduling without any optimization or control by a system according to the present disclosure. The minimum charging duration is taken first, followed by the remaining charging duration until a maximum SoC, which is not strictly necessary to meet the charging goal of the EVs, followed by flexible time which is not utilized. In this example, this results in an increase and peak of the EV charging demand to the overall power grid demand when all EVs are plugged-in and charging simultaneously, which may be undesirable for the sake of maintaining a supply to this demand, or for the sake of protecting and prolonging electrical infrastructure. The shaded portion 504 under the EVs demand contribution curve 502 represents the demand curve had the EVs' charging been stopped upon reaching their target SoCs. This difference, in addition to the remaining time flexibility, enables the EV charging to be scheduled and controlled in an optimized way towards a given objective(s).

FIG. 6 shows upcoming periods of predicted demand excess and supply surplus. With optimization according to the present disclosure, for example for supply-demand balancing, an objective during the demand excess may be, for example, to reduce the contribution of EV charging by a given amount, to reduce the contribution of EV charging below a given threshold, or simply to reduce the contribution of EV charging as much as possible. In this example, the objective is to reduce the contribution of EV charging as much as possible during the target time period 602, which here is a predicted period of higher power demand or excess power demand in the power grid. The optimization may avoid unnecessary charging and/or postpone charging as much as possible, subject to constraints, as shown in the example of FIG. 6. For example, EV charging may be scheduled such that EV charging that may be done outside of the target time period 602 while meeting the EV charging goals is scheduled outside of the target time period 602. This may result in a curtailment of the aggregate charging load of the EVs in the power system during the target time period 602.

An objective during the power supply surplus, or higher power supply, may be to increase the EV charging by a given amount, to increase the EV charging above a given threshold, or simply to increase the EV charging as much as possible. In this example, an objective is to increase the EV charging as much as possible during a secondary target time period 604, which here is a predicted period of supply surplus, or higher supply in the power grid. The optimization may schedule unnecessary charging at times 606, 608, meaning charging beyond the target SoCs of the EVs. The optimization may schedule charging 606 during this period of supply surplus during the secondary target time period 604 rather than at times of lower supply. Thus, the optimization may increase the aggregate charging load of the EVs in the power system during the secondary target time period 604.

As a result of these optimization decisions, some charging that would otherwise have been performed to EVs during a period of demand excess 602 was instead scheduled in the period of supply surplus 604. Other EV charging was not scheduled because it was not strictly necessary to meet the EV charging goals. However, in some embodiments or situations, not scheduling unnecessary charging may be undesirable and the optimization may account for this. For example, an issue may occur when an EV that was charged in a first charging session arrives again later with a lower SoC corresponding to the lower SoC reached during the first charging session. This can limit the future charging flexibility of this EV since the EV will likely require more charging in the second subsequent charging session than it would have needed had it received more charging, and thus a higher SoC, during the first charging session.

In some embodiments, the scheduling charging of at least some of the EVs outside of the target time period comprises scheduling no charging of the at least some of the EVs during the predicted upcoming period of higher power demand, meaning the charging of these EVs is off. In some embodiments, the charging scheduling involves charging at least some EVs during the target time period at a curtailed charging rate that is lower than a charging rate that is available to a respective individual EV during the target time period. Thus, rather than not charging some EVs during the target time period, those EVs may be instead charged at a lower charging rate during the target time period.

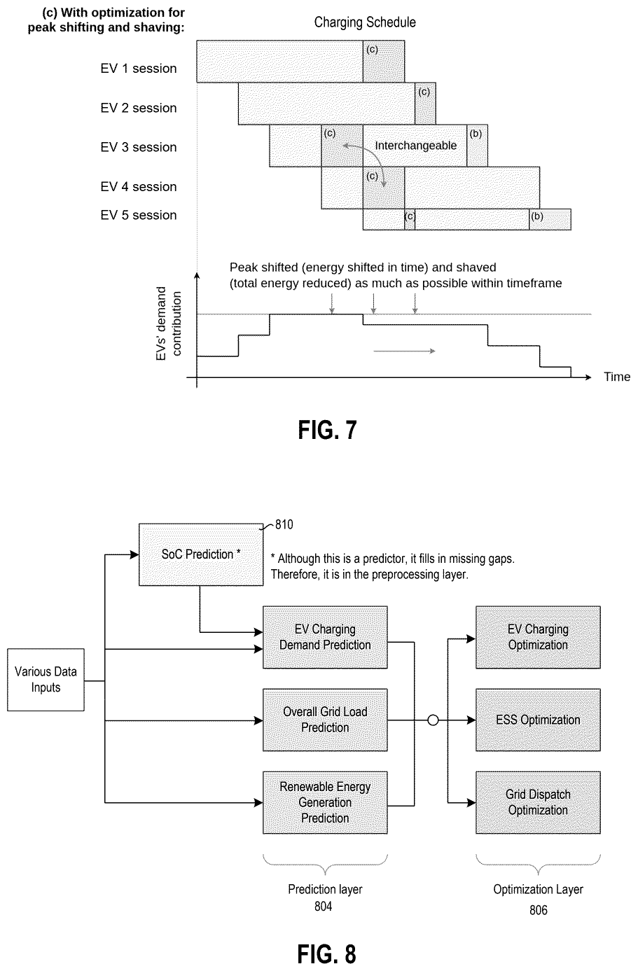

FIG. 7 shows example charging scheduling where an optimization objective is peak shifting and shaving, meaning to flatten the demand curve by strategically shifting some EV charging away from the original peak, and/or by selectively sacrificing some charging that is not strictly necessary for reaching the target SoCs. Shifting EV charging load generally means scheduling the EV charging load at a different time than it would have otherwise occurred without any optimization, for example an EV could typically begin charging as soon as it is plugged into a charge point and continue charging continuously at a full charging rate until it reaches its maximum SoC or until it is unplugged. Though not unique to this example of FIG. 7, some charging times are shown to be interchangeable, representing that there are multiple, equally optimal solutions to this optimization problem, of which only one is needed.

The optimizations may be done at lower levels of a power system, at higher levels, or a combination of these. For example, if the power system is a local distribution grid of a city, optimizations may be done for the entire grid, or for each of one or more subsets of the grid, for example for neighborhood subgrids, or for any combination of these.

An example of power system infrastructure being overloaded is now described. Referring to FIG. 1, assume that it around 5 pm on a workday during the summer when many homes are running the electric air conditioners of their homes, and several people in a neighborhood arrive back at home (for example from work) in their EVs. In this example, the people in the neighborhood all live at homes that are serviced by a street level transformer 118 servicing their neighbourhood in FIG. 1. Upon arrival at home, they connect their EVs 122 to charge points at their homes, and the EVs begin charging immediately. The people also turn on various electrical devices in their homes, such as stoves, ovens, and washing machines. The customer demand during this on-peak time is very high.

As the people who live in homes serviced by the same street level transformer 118 begin to own or use more EVs, the load on the subset of the power grid infrastructure that services these people will increase. At a certain point, the number of EVs at these homes will likely reach a point at which the demand (load) will at times exceed the operational limits of electrical components in the subset of the power grid infrastructure that services these people, which includes the particular street level transformer 118. The exceeding of the operational limits of the component(s) will constitute an overloading of this subset of the power grid, thereby potentially causing physical damage to at least some of the electrical components in the power grid, possibly including the particular street level transformer 118. Accordingly, a present power control system may provide separate control to this subset of the power grid, as well as to other subsets of the grid. The separate control may include performing peak shifting or shaving or supply-demand balancing on this subset of the grid, as well as on other subsets of the grid. In doing so, the power control system may consider the EVs associated with this subset of the grid as a virtual ESS.

Some decision variables in optimizations are now described. The present disclosure includes examples of optimization objectives as well as examples of how objectives may be achieved. An objective is generally achieved by the decision variables of the optimization problem. The decision variables may represent if and when to charge or discharge assets, and which assets those were (for example EVs or ESSs). This may be subject to constraints such as when those EVs are available to charge and how much they needed to charge. In other words, their times of arrival, current SoC, target SoC, target time of departure, etc. These may be treated as parameters or hard constraints, but may represent an additional opportunity to improve a performance of an optimization towards a desired objective(s). Which EVs are available to charge, when they are available to charge, and how much they need to charge may optionally be controlled by the system as part of its optimization, for example by having additional or alternative decision variables for price incentivization. With price incentivization, the system may use adjustable pricing to incentivize EV users to charge at or until certain times or SoCs, such that the optimization objective benefits, for example such that fossil fuel generation is minimized. For example, pricing incentivization may be used to have more EVs plugged-in at the same time, potentially increasing the momentary capacity of the virtual ESS formed by the EVs.

Missing data or information and an ability to infer missing information is now described. Sometimes some data is missing, unavailable, or to some extent out-of-date, for example due to hardware or software limitations of the equipment that is connected to the intelligent EV charging solution and depending on how it is connected. As an example, regarding the control of EV charging hardware via the Open Charge Point Protocol (OCPP) protocol, there does not exist a way to obtain SoC of vehicles through OCPP. This may be because the SoC of vehicles is not communicated through the OCPP protocol version 1.6j. There is presently no universal solution to extract the SoC of vehicles. A contributing factor to this is that commonly used sockets in North America support basic data transfer but some or most do not include the SoC. Without knowing the SoC of individual vehicles that are connected to EV chargers in the smart grid, it can be difficult to intelligently coordinate EV charging without knowing how much longer the vehicle will need to finish charging.

According to an aspect, in some embodiments, the present disclosure provides methods and systems that infer missing data required or desired for optimization, for example based on incomplete data coming from EVs or other devices or sources. Method and systems are provided that fill-in missing data that is not available to the system at a given time. Examples of missing data that may be inferred in such a manner include SoC, GPS coordinates of EVs, EV user demand and usage patterns, power draw, and so on. In addition, information relating to assets not controlled by a power control system or connected to or otherwise associated with the power grid may be inferred. Although, this may have an effect on the status of the power grid at some level, which may be inputted to an optimizer for the purpose of improving performance.

Missing information that needs to be inferred may relate to assets not actively controlled by, or directly controlled by a power control system. However, these inputs may still be useful as inputs to an EV charging optimizer. These could include, for example, one or more of renewable energy sources, non-participating residential and commercial loads, behind-the-meter distributed generation, transient or temporary loads, and public infrastructure.

As an example, consider that incoming data from an EV does not include certain types of information and/or includes incomplete information that would be used by a power control system. The power control system may fill-in missing data as best as it can for example using supplemental data sources, such as weather providers or a GIS service (such as Google™ Maps). The system may use models, such as artificial intelligence (AI) techniques, to fill-in missing data that cannot be obtained from supplementary data sources. This may be operational data such as energy consumption for a given city block and loading (passenger and/or freight).

In an embodiment, the power control system may use a number of accurate data inputs, such as some of those outlined herein including in Table 1 above, in order to function and achieve an optimization objective. However, sometimes, some inputs may not be available, for example due to software limitations, hardware limitations, or other reasons. For example, EV battery SoC is not available through EV charging hardware using OCPP 1.6j due to a limitation in the protocol, or due to many of the sockets currently used in North America not supporting this signal. As such, methods and systems are provided that fill-in missing data and infer missing data, for example using machine learning techniques. Such methods may be employed as part of the power control system to provide data that may be desired or necessary for its function.

FIG. 8 is a diagram showing example functional layers and information sources which includes a mechanism for filling-in some missing data relating to SoC. FIG. 8 focuses on an SoC prediction module 810 part of a preprocessing layer and on aspects of a prediction layer 804 and optimization layer 806 which may be enabled by the SoC prediction, all beginning with the available data inputs. Note that “Grid Dispatch Optimization” may refer to grid export and import (power flow to and from the electrical grid, respectively), which may tie into the EV charging optimization.

By receiving or acquiring information from other sources, such as seasonality information, historical usage patterns of EV users, and demand predictions, a power control system may infer the SoC of EVs. If the SoC of an EV is known, it may be possible to more accurately optimize for intelligent EV charging to ensure that the EV users' needs and preferences are satisfied while enabling the use of the EV essentially as part of a virtual ESS. The EV charging demand prediction information according to FIG. 8 may be in terms of EVs' current SoCs and the EV charging goals, such as their users' target SoC at a specified future time and so on. While some information such as a target SoCs may come from a computing device, such as via an application on a device associated with the EV user, a current SoC may come from a SoC prediction module 810 shown, which may receive information (such as “Various data inputs) from one or more sources.

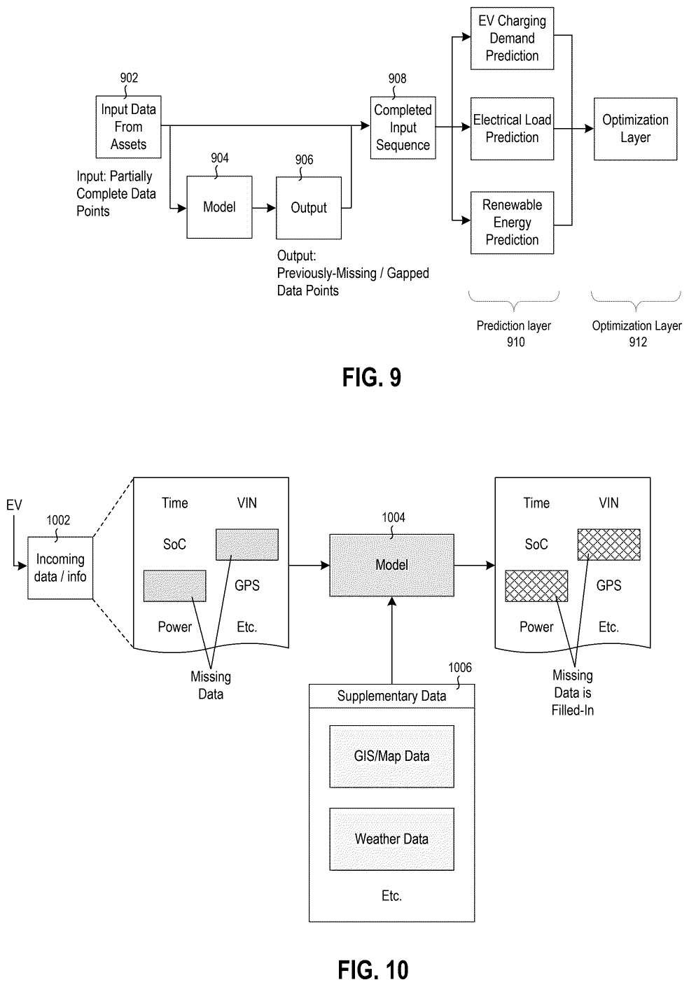

FIG. 9 is a diagram showing example functional layers and information sources which includes a more general mechanism for filling-in missing data or information. Unlike FIG. 8, FIG. 9 is not necessarily directed to filling-in SoC information. The filling-in of missing data or other information to be used by a power control system that may be desirable but unavailable may be done in a similar manner as for SoC data. The “Completed Input Sequence” is a modified form of the “Input Data From Assets”, not only after preprocessing but also after inferring any missing quantities.

Input data from assets 902 may include, for example, primary input data collected from EVs and other related third party sources such as weather, traffic data, etc.

Model module 904 and output module 906 may handle missing data or other information. Since the data from input sources may be incomplete, the model 904 and output module 906, which form a layer, may serve as a mechanism to handle missing information in a graceful manner. Simulated or interpolated data may be used to fill in missing values based on historical trends or averages. For example, if a EV state of charge is missing, then it could be estimated based on odometer readings and recent charging data.

A completed input sequence 908 may comprise the incomplete input data from assets, as well as supplementary data from the model/output layer.

Using the completed input sequence 908, a prediction layer 910 may predict, for example, future charging demand, electrical load, renewable energy generation or availability, and/or other metrics.

Optimization layer 912 may use outputs from the prediction layer 910 to generate signals such as EV charging control signals, or insights for the user.

FIG. 10 is a diagram showing components or modules of an example subsystem for filling-in missing data or other information. The example includes examples of specific pieces of information 1002 from an EV or EV charger that may be desirable for use by a power control system, for example telemetry data, but may or may not be available. This may include data such as, for example, state of charge, odometer readings, GPS location, vehicle identification number (VIN), and so on. This data may be incomplete due to sensor failures, data transmission errors, and so on. A model 1004 may be provided that uses the pieces of information that are available, as well as supplementary information 1006 such as GIS/map data, weather data, and so on, to infer missing information. For missing data within the incoming data set, data imputation techniques may be employed. In cases where direct data is not available (for example exact battery SOC at a particular point in time), interpolation may be used. For more complex gaps, predictive modelling techniques may be utilized. For instance, if the exact location of an EV is unknown due to missing GPS data, a predictive model may be used to determine its GPS coordinates using historical patterns, charging habits, traffic data, and so on. After supplementing the partial input data with external data and data imputation techniques, the inferred data is assembled to create a completed input sequence.

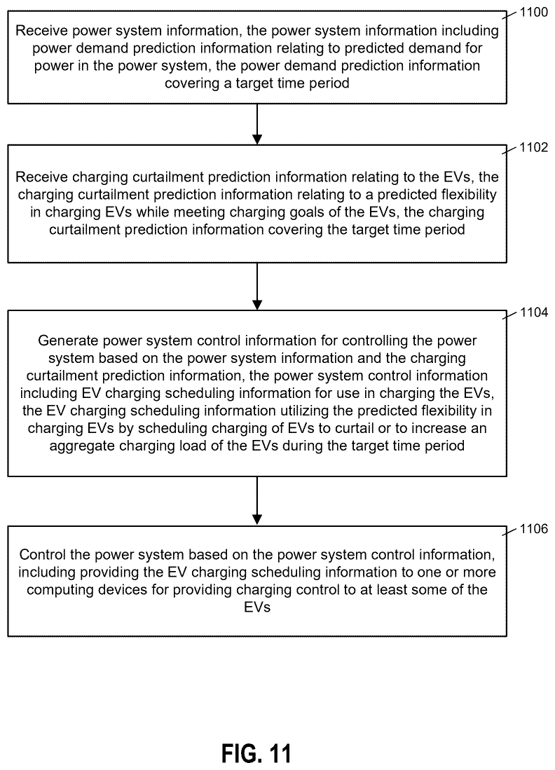

FIG. 11 is a process flow diagram of an example method according to the present disclosure relating to providing control to a power system which includes EVs. The example method may be performed at or by one or more electronic devices each having one or more computer processors and computer-readable memory. In addition, the method may comprise providing control in relation to a power system having a plurality of electric vehicles (EVs), wherein the EVs are chargeable with power from the power system.

At block 1100, the process receives power system information, the power system information including power demand prediction information relating to predicted demand for power in the power system. The power demand prediction information may cover a target time period.

At block 1102, the process receives charging curtailment prediction information relating to the EVs. The charging curtailment prediction information may relate to a predicted flexibility in charging EVs while meeting charging goals of the EVs. The charging curtailment prediction information may cover the target time period.

At block 1104, the process generates power system control information for controlling the power system based on the power system information and the charging curtailment prediction information. The power system control information includes EV charging scheduling information for use in charging the EVs. The EV charging scheduling information utilizes the predicted flexibility in charging EVs by scheduling charging of EVs to curtail or to increase an aggregate charging load of the EVs during the target time period.

At block 1106, the process controls the power system based on the power system control information. The control may include providing the EV charging scheduling information to one or more computing devices for providing charging control to at least some of the EVs.

In regard to terminology and generalization, throughout the present disclosure, terms such as charger and charge point may refer technically to electric vehicle supply equipment (EVSE). An EV may be a car or any other type of electric vehicle, such as an electric boat or aircraft. As such, the present disclosure applies equally to, for example, electric uncrewed aerial vehicles (UAVs, drones) such as what might be used to deliver goods or supplies such as medicine throughout a region. Furthermore, an EV may be a traditional EV, but the term also includes plug-in hybrid EVs (PHEVs), fuel-cell EVs (FCEVs), and any other type of technology of vehicle whose energy may be resupplied via electricity. An EV's battery refers equally to any other form of energy storage, which may be external to the vehicle. The state of charge (SoC) of an EV or an energy storage system (ESS) refers equally to the energy level of its energy storage. Similarly, charging and discharging an EV or ESS refer equally to its energy level increasing or decreasing, regardless of how it is stored.

EVs connected to and controlled by a power control system according to the present disclosure may be individually owned and charged at disparate (separately-metered) sites, or may include EVs under common ownership or other association, which may be charged at a one or more commonly-metered location, for example a transit depot. The present power control system may incorporate fleet EVs through direct interaction or integration with systems managing energy use and charging at the charging site serving the fleet, or through arm's length communication paths such as automated or semi-automated protocols for energy market transactions, for example Open Automated Demand Response (OpenADR).

Depending on the level of integration of a fleet of EVs with a power control system, the granularity of the input data and/or control over fleets of EVs may be limited. For example, only a typical arrival and departure time may be available for a number of EVs. Or, as another example, the charging of an EV fleet may only be able to be controlled externally in aggregate, meaning the charging of all relevant EVs being controlled together. Furthermore, controlling EVs in aggregate may be desirable and may be done by clustering similar EVs or EV sessions together, which may mean, for instance, those having similar attributes, to achieve a better outcome when controlling EV charging in aggregate. Such a process may be done as part of the preprocessing layer, and may utilize machine learning (ML) clustering techniques.

Several types of data or information that may be relevant to the operation of a power control system may be inferred for specific classes of fleet based on publicly available information sources such as transit schedules and real-time delay trackers, traffic and weather conditions, demand levels for services such as deliveries or taxi rides, factors dictating utilization of specialized EV fleets such as snow-clearing equipment, and other factors. Control over EVs or EV fleets not directly integrated with the power control system may be limited or not feasible, but their input data may be a useful input to the power control system nonetheless to get a better ‘picture’ of demand, make more accurate forecasts of electrical demand, and so on, to improve optimization performance.

In addition, optimizations in a power control system may be implemented and function at a level of an electricity system when some or all of that electricity system is under abnormal operation. Abnormal operation may be caused, for example, by an electricity producers supplying a limited or zero amount of power, and/or by electrical infrastructure being damaged or undergoing repair. Information about the nature of the abnormal operation, and where and how the power system is affected, may be used in optimizations by the power control system if they are available to update the parameters and constraints of an optimization problem, such as a reduced electrical supply, or how much power can be transferred through a given piece of electrical infrastructure such as a power line. For example, if a feeder entrance transformer stops functioning without a backup, it may effectively become a separate power system to be controlled by an optimization, for example by balancing its supply and demand separately. As another example, if an electricity producer stops functioning without a backup, an optimization of the power control system may strictly limit the SoCs of EVs to their target SoCs or some lower amount. An optimization by the power control system may use predictions of how the parameters and constraints may be affected, in turn, by predictions of abnormal operation. Abnormal operations such as scheduled maintenance within a power system may be known in advance.

In some embodiments, algorithms, techniques, and/or approaches according to the present disclosure may be performed or based on artificial intelligence (AI) algorithms, techniques, and/or approaches. This includes but is not limited to optimizers and/or predictors according to the present disclosure, as well as controlling power systems and controlling assets such as EVs and EV charging infrastructure.

In some embodiments, the Al algorithms and techniques may include machine learning techniques.

Machine Learning (ML) may be used in power systems, including power control systems and EV charging control systems. Machine learning systems may be used to predict or estimate information or data according to the present disclosure, for example data associated with one or more assets, for example SoC of EVs, usage patters of EVs, telematics data associated with one or more EVs. Machine learning models may be used, as a mere example, to predict power demand and supply in a power grid, abilities to curtail or increase an aggregate charging load of EVs, future resource availability, demand requirements, EV owner behaviour, and/or control assets in a system, for instance using one or more optimizations. Predictions may be used to control or schedule charging interactions, to schedule EV charging, energy generation, power distribution, energy storage, and/or pricing to optimally coordinate these energy systems to achieve various objectives such as power supply-demand balancing, peak shifting or shaving, cost minimization, efficiency maximization, or optimal use of local renewable energy. Further, predictors and/or optimizers, and the training thereof, may also use or be based on machine learning techniques.

A machine learning algorithm or system may receive data, for example historical data, streaming controllable asset data, environmental data, and/or third party data, and, using one or more suitable machine learning algorithms, may generate one or more datasets. Example types of machine learning algorithms include but are not limited to supervised learning algorithms, unsupervised learning algorithms, reinforcement learning algorithms, semi-supervised learning algorithms (e.g. where both labeled and unlabeled data is used), regression algorithms (for example logistic regression, linear regression, and so forth), regularization algorithms (for example least-angle regression, ridge regression, and so forth), artificial neural network algorithms, instance based algorithms (for example locally weighted learning, learning vector quantization, and so forth), Bayesian algorithms, decision tree algorithms, clustering algorithms, and so forth. Further, other machine learning algorithms may be used additionally or alternatively. In some embodiments, a machine learning algorithm or system may analyze data to identify patterns and/or sequences of activity, and so forth, to generate one or more datasets.

A system, such as a power control system, may comprise one or more control policies. The control policies of the system may be based on trained machine learning based systems. In this sense, a control policy may be part of a control agent. A control agent observes its environment, herein referred to a control environment, and takes action based on its observations, or percepts, of the control environment. The taking of action is referred to as controlling the system. Depending on the state of the environment, taking action may involve taking no action at all, for example if there has been little or no change in the state since the last time the agent took action. Thus, doing nothing is a valid action in a set of actions in the action space of the controller. In an embodiment, the present systems and methods may exploit the flexibility of controllable assets in the power system to achieve improved performance of the system. For example, the flexibility of controllable assets may be exploited in response to changes in the control environment.

In an embodiment, online machine learning may be employed. Online machine learning is a technique of machine learning where data becomes available sequentially over time. The data is utilized to update a predictor for future data at each step in time (e.g. time slot). This approach of online machine learning may be contrasted to approaches that use batch learning wherein learning performed on an entire or subset of training data set. Online machine learning is sometimes useful where the data varies significantly over time, such as in power or energy pricing, commodity pricing, and stock markets. Further, online machine learning may be helpful when it is not practical or possible to train the agent over the entire or subset of data set.

In embodiments according to the present disclosure, training of a machine learning system, such as a predictor or forecaster or optimizer, may be based on offline learning and/or online learning where the streaming real-time data may be combined with at least some data, for example from a database, to train the machine learning system in real-time or near real-time. Over time, a machine learning system may be retrained, for example with newer or different training data.

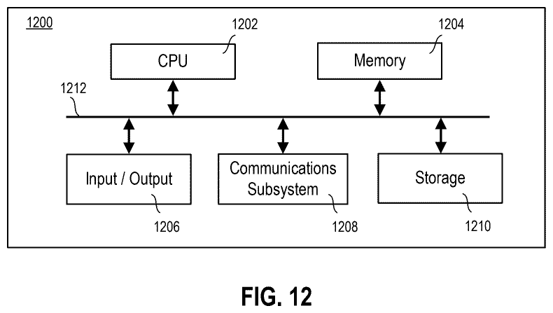

FIG. 12 is a block diagram of an example computerized device or system 1200 that may be used in implementing one or more aspects or components of an embodiment according to the present disclosure.

For example, system 1200 may be used to implement a computing device or system, such as a power control system, an EV charging control system, a controller, an optimizer, a predictor, and so on, which may be used with a device, system or method according to the present disclosure. Thus, one or more systems 1200 may be configured to implement one or more portions of the systems or apparatuses or methods according to the present disclosure.

Computerized system 1200 may comprise one or more of classic, analog, electronic, digital, and quantum computing technologies. Computerized system 1200 may include one or more of a computer processor device 1202, memory 1204, a mass storage device 12120, an input/output (I/O) interface 1206, and a communications subsystem 1208. A computer processor device may be any suitable device(s), and encompasses various devices, systems, and apparatus for processing data and instructions. These include, as examples only, one or more of a hardware processor, a digital processor, an electronic processor, a quantum processor, a programmable processor, a computer, a system on a chip, and special purpose logic circuitry such as an ASIC (application-specific integrated circuit) and/or FPGA (field programmable gate array). In addition, system 1200 may include hardware dedicated to one or more specific purposes, such as a graphics processing unit (GPU), or a tensor processing unit (TPU) or other artificial intelligence accelerator ASIC, for example for machine learning (ML).

Memory 1204 may be configured to store computer readable instructions, that when executed by processor 1202, cause the performance of operations, including operations in accordance with the present disclosure.

One or more of the components or subsystems of computerized system 1200 may be interconnected by way of one or more buses 1212 or in any other suitable manner.

The bus 1212 may be one or more of any type of several bus architectures including a memory bus, storage bus, memory controller bus, peripheral bus, or the like. The processor 1202 may comprise any type of electronic data processor. The memory 1204 may comprise any type of system memory such as dynamic random access memory (DRAM), static random access memory (SRAM), synchronous DRAM (SDRAM), read-only memory (ROM), a combination thereof, or the like. In an embodiment, the memory may include ROM for use at boot-up, and DRAM for program and data storage for use while executing programs.

The storage device 1210 may comprise any type of storage device configured to store data, programs, and other information and to make the data, programs, and other information accessible via the bus 1212. The storage device may be adapted to store one or more databases and/or data repositories, each of which is generally an organized collection of data or other information stored and accessed electronically via a computer. The term database or repository may thus refer to a storage device comprising a database. The mass storage device 1210 may comprise one or more of a solid state drive, hard disk drive, a magnetic disk drive, an optical disk drive, or the like. In some embodiments, data, programs, or other information may be stored remotely, for example in the cloud. Computerized system 1200 may send or receive information to the remote storage in any suitable way, including via communications subsystem 1208 over a network or other data communication medium.

The I/O interface 1206 may provide interfaces for enabling wired and/or wireless communications between computerized system 1200 and one or more other devices or systems. Furthermore, additional or fewer interfaces may be utilized. For example, one or more serial interfaces such as Universal Serial Bus (USB) (not shown) may be provided. Further, system 1200 may comprise or be communicatively connectable to a display device, and/or speaker device, a microphone device, an input device such as a keyboard, button, pointer, mouse, touch screen display, microphone, camera, scanner, or any other type of input device.

Computerized system 1200 may be used to configure, operate, control, monitor, sense, and/or adjust devices, systems, and/or methods according to the present disclosure.

A communications subsystem 1208 may be provided for one or both of transmitting and receiving signals over any form or medium of digital data communication, including a communication network. Examples of communication networks include a local area network (LAN), a wide area network (WAN), telecommunications network, cellular network, an inter-network such as the Internet, and peer-to-peer networks such as ad hoc peer-to-peer networks. Communications subsystem 1208 may include any component or collection of components for enabling communications over one or more wired and wireless interfaces. These interfaces may include but are not limited to USB, Ethernet (e.g. IEEE 802.3), high-definition multimedia interface (HDMI), Firewire™ (e.g. IEEE 1374), Thunderbolt™, WiFi™ (e.g. IEEE 802.11), WiMAX (e.g. IEEE 802.16), Bluetooth™, or Near-field communications (NFC), as well as General Packet Radio Service (GPRS), Universal Mobile Telecommunications System (UMTS), Long-Term Evolution (LTE), LTE-A, 5G NR (New Radio), satellite communication protocols, and dedicated short range communication (DSRC). Communication subsystem 1208 may include one or more ports or other components (not shown) for one or more wired connections. Additionally or alternatively, communication subsystem 1208 may include one or more transmitters, receivers, and/or antenna elements (none of which are shown). Further, system 1200 may comprise clients and servers.

Computerized system 1200 of FIG. 12 is merely an example and is not meant to be limiting. Various embodiments may utilize some or all of the components shown or described. Some embodiments may use other components not shown or described but known to persons skilled in the art.

Logical operations of the various embodiments according to the present disclosure may be implemented as (i) a sequence of computer implemented steps, procedures, or operations running on a programmable circuit in a computer, (ii) a sequence of computer implemented operations, procedures, or steps running on a specific-use programmable circuit; and/or (iii) interconnected machine modules or program engines within the programmable circuits. The computerized device or system 1200 of FIG. 12 may practice all or part of the recited methods or operations, may be a part of systems according to the present disclosure, and/or may operate according to instructions in computer-readable storage media. Such logical operations may be implemented as modules configured to control a computer processor, such as processor 1202, to perform particular functions according to the programming of the module. In other words, a computer processor, such as processor 1202, may execute the instructions, steps, or operations according to the present disclosure, including of the one or more of the blocks or modules. For example, one or more of the modules or blocks or operations and so on according to the present disclosure may be configured to control processor 1202. For example, one or more of the modules or blocks or operations and so on may include but are not limited to, for example, a power control system, an EV charging control system, a data processor, a predictor, an optimizer, a controller, an application, and so on. At least some of these blocks or modules may be stored on storage device 1210 and loaded into memory 1204 at runtime or may be stored in other computer-readable memory locations.

The concepts of real-time and near real-time may be defined as providing a response or output within a pre-determined time interval, usually a relatively short time. A time interval for real-time is generally shorter than an interval for near real-time. Mere non-limiting examples of predetermined time intervals may include the following as well as values below, between, and/or above these figures: 10 s, 60 s, 5 min, 10 min, 20 min, 30 min, 60 min, 2 hr, 4 hr, 6 hr, 8 hr, 10 hr, 12 hr, 1 day.

The term module used herein may refer to a software module, a hardware module, or a module comprising both software and hardware. Generally, software includes computer executable instructions, and possibly also data, and hardware refers to physical computer hardware.

The term ‘data’ generally refers to raw or unorganized facts whereas ‘information’ generally refers to processed or organized data. However, the terms are generally used synonymously herein unless indicated otherwise.

Embodiments and operations according to the present disclosure may be implemented in digital electronic circuitry, and/or in computer software, firmware, and/or hardware, including structures according to this disclosure and their structural equivalents. Embodiments and operations according to the present disclosure may be implemented as one or more computer programs, for example one or more modules of computer program instructions, stored on or in computer storage media for execution by, or to control the operation of, one or more computer processing devices such as a processor. Operations according to the present disclosure may be implemented as operations performed by one or more processing devices on data stored on one or more computer-readable storage devices or media, and/or received from other sources.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not necessarily provided as to whether the embodiments described herein are implemented as a computer software, computer hardware, electronic hardware, or a combination thereof.

In at least some embodiments, one or more aspects or components may be implemented by one or more special-purpose computing devices. The special-purpose computing devices may be any suitable type of computing device, including desktop computers, portable computers, handheld computing devices, networking devices, or any other computing device that comprises hardwired and/or program logic to implement operations and features according to the present disclosure.

Embodiments of the disclosure may be represented as a computer program product stored in a machine-readable medium (also referred to as a computer-readable medium, a processor-readable medium, or a computer usable medium having a computer-readable program code embodied therein). The machine-readable medium may be any suitable tangible, non-transitory medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations may also be stored on the machine-readable medium. The instructions stored on the machine-readable medium may be executed by a processor or other suitable processing device, and may interface with circuitry to perform the described tasks.

The structure, features, accessories, and/or alternatives of embodiments described and/or shown herein, including one or more aspects thereof, are intended to apply generally to all of the teachings of the present disclosure, including to all of the embodiments described and illustrated herein, insofar as they are compatible. Thus, the present disclosure includes embodiments having any combination or permutation of features of embodiments or aspects herein described.

In addition, the steps and the ordering of the steps of methods and data flows described and/or illustrated herein are not meant to be limiting. Methods and data flows comprising different steps, different number of steps, and/or different ordering of steps are also contemplated. Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The embodiments according to the present disclosure are intended to be examples only. Alterations, modifications and variations may be effected to the particular embodiments by those of skill in the art without departing from the scope, which is defined solely by the claims appended hereto.

The terms “a” or “an” are generally used to mean one or more than one. Furthermore, the term “or” is used in a non-exclusive manner, meaning that “A or B” includes “A but not B,” “B but not A,” and “both A and B” unless otherwise indicated. In addition, the terms “first,” “second,” and “third,” and so on, are used only as labels for descriptive purposes, and are not intended to impose numerical requirements or any specific ordering on their objects.

1. A system, comprising:
a computer-readable storage medium having executable instructions; and
one or more computer processors configured to execute the instructions to provide control in relation to a power system having a plurality of electric vehicles (EVs), wherein the EVs are chargeable with power from the power system, the instructions to:
receive power system information, the power system information including power demand prediction information relating to predicted demand for power in the power system, the power demand prediction information covering a target time period;
receive charging curtailment prediction information relating to the EVs, the charging curtailment prediction information relating to a predicted flexibility in charging EVs while meeting charging goals of the EVs, the charging curtailment prediction information covering the target time period;
generate power system control information for controlling the power system based on the power system information and the charging curtailment prediction information, the power system control information including EV charging scheduling information for use in charging the EVs, the EV charging scheduling information utilizing the predicted flexibility in charging EVs by scheduling charging of EVs to curtail or to increase an aggregate charging load of the EVs during the target time period; and
control the power system based on the power system control information, including providing the EV charging scheduling information to one or more computing devices for providing charging control to at least some of the EVs.

2. The system according to claim 1, wherein the controlling the power system based on the power system control information comprises performing at least one of:
power supply-demand balancing in the power system, and
power peak shaving or peak shifting in the power system, and
wherein the controlling the power system is based on the EV charging scheduling information.

3. The system according to claim 1,
wherein the target time period includes a predicted upcoming period of higher power demand in the power system, and
wherein the EV charging scheduling information includes scheduling of charging of EVs outside of the target time period to curtail the aggregate charging load of the EVs during the target time period.

4. The system according to claim 1, wherein the charging curtailment prediction information comprises information relating to at least one of:
a prediction of an aggregate number of EVs that will be available during the target time period to have their charging curtailed; and
a prediction of an aggregate amount of EV charging load that will be available during the target time period to be curtailed.

5. The system according to claim 1, the instructions further to:
generate the charging curtailment prediction information based on at least one of:
historical information comprising at least one of:
an aggregate number of EVs that were available during a time period to have their charging curtailed;
an aggregate amount of EV charging load that was available during a time period to be curtailed;
EV charging goal information of EVs comprising at least one of: target charging completion date and time information for a given EV, and target EV battery state of charge (SoC) information; and
EV charging and use information comprising EV departure date and time information for a given EV, and EV battery state of charge (SoC) information at the time of the EV departure, and
at least one of weather information and traffic information.

6. The system according to claim 1, wherein the charging goals of the EVs comprises at least one of: target charging completion date and time information, and target EV battery state of charge (SoC) information at target charging completion.

7. The system according to claim 1, wherein the power system control information comprises separate control information for each of at least two subsets of the power system, and wherein the controlling the power system comprises separately controlling each of the at least two subsets of the power system.

8. The system according to claim 1, wherein at least one of:
the scheduling charging of at least some of the EVs outside of the target time period comprises scheduling no charging of the at least some of the EVs during the predicted upcoming period of higher power demand; and
the EV charging scheduling information utilizes the predicted flexibility in charging EVs by scheduling charging of individual EVs of at least some of the EVs during the target time period at a curtailed charging rate that is lower than a charging rate that is available to a respective individual EV during the target time period.

9. A method comprising:
at one or more electronic devices each having one or more processors and computer-readable memory, to provide control in relation to a power system having a plurality of electric vehicles (EVs), wherein the EVs are chargeable with power from the power system:
receiving power system information, the power system information including power demand prediction information relating to predicted demand for power in the power system, the power demand prediction information covering a target time period;
receiving charging curtailment prediction information relating to the EVs, the charging curtailment prediction information relating to a predicted flexibility in charging EVs while meeting charging goals of the EVs, the charging curtailment prediction information covering the target time period;
generating power system control information for controlling the power system based on the power system information and the charging curtailment prediction information, the power system control information including EV charging scheduling information for use in charging the EVs, the EV charging scheduling information utilizing the predicted flexibility in charging EVs by scheduling charging of EVs to curtail or to increase an aggregate charging load of the EVs during the target time period; and
controlling the power system based on the power system control information, including providing the EV charging scheduling information to one or more computing devices for providing charging control to at least some of the EVs.

10. The method according to claim 9, wherein the controlling the power system based on the power system control information comprises performing at least one of:
power supply-demand balancing in the power system, and
power peak shaving or peak shifting in the power system, and
wherein the controlling the power system is based on the EV charging scheduling information.

11. The method according to claim 9- or 10,
wherein the target time period includes a predicted upcoming period of higher power demand in the power system, and
wherein the EV charging scheduling information includes scheduling of charging of EVs outside of the target time period to curtail the aggregate charging load of the EVs during the target time period.

12. The method according to claim 9, wherein the charging curtailment prediction information comprises information relating to at least one of:
a prediction of an aggregate number of EVs that will be available during the target time period to have their charging curtailed; and
a prediction of an aggregate amount of EV charging load that will be available during the target time period to be curtailed.

13. The method according to claim 9, further comprising:
generating the charging curtailment prediction information based on at least one of:
historical information comprising at least one of:
an aggregate number of EVs that were available during a time period to have their charging curtailed;
an aggregate amount of EV charging load that was available during a time period to be curtailed;
EV charging goal information of EVs comprising at least one of: target charging completion date and time information for a given EV, and target EV battery state of charge (SoC) information; and
EV charging and use information comprising EV departure date and time information for a given EV, and EV battery state of charge (SoC) information at the time of the EV departure, and
at least one of weather information and traffic information.

14. The method according to claim 9, wherein the charging goals of the EVs comprises at least one of: target charging completion date and time information, and target EV battery state of charge (SoC) information at target charging completion.

15. The method according to claim 9, wherein the power system control information comprises separate control information for each of at least two subsets of the power system, and wherein the controlling the power system comprises separately controlling each of the at least two subsets of the power system.

16. The method according to claim 9, wherein at least one of:
the scheduling charging of at least some of the EVs outside of the target time period comprises scheduling no charging of the at least some of the EVs during the predicted upcoming period of higher power demand; and
the EV charging scheduling information utilizes the predicted flexibility in charging EVs by scheduling charging of individual EVs of at least some of the EVs during the target time period at a curtailed charging rate that is lower than a charging rate that is available to a respective individual EV during the target time period.

17. A non-transitory computer-readable medium having computer-readable instructions stored thereon, the computer-readable instructions executable by at least one processor to cause the performance of operations relating to providing control in relation to a power system having a plurality of electric vehicles (EVs), wherein the EVs are chargeable with power from the power system, the operations comprising:
receiving power system information, the power system information including power demand prediction information relating to predicted demand for power in the power system, the power demand prediction information covering a target time period;
receiving charging curtailment prediction information relating to the EVs, the charging curtailment prediction information relating to a predicted flexibility in charging EVs while meeting charging goals of the EVs, the charging curtailment prediction information covering the target time period;
generating power system control information for controlling the power system based on the power system information and the charging curtailment prediction information, the power system control information including EV charging scheduling information for use in charging the EVs, the EV charging scheduling information utilizing the predicted flexibility in charging EVs by scheduling charging of EVs to curtail or to increase an aggregate charging load of the EVs during the target time period; and
controlling the power system based on the power system control information, including providing the EV charging scheduling information to one or more computing devices for providing charging control to at least some of the EVs.

18. The non-transitory computer-readable medium according to claim 17, wherein the controlling the power system based on the power system control information comprises performing at least one of:
power supply-demand balancing in the power system, and
power peak shaving or peak shifting in the power system, and
wherein the controlling the power system is based on the EV charging scheduling information.

19. The non-transitory computer-readable medium according to claim 17,
wherein the target time period includes a predicted upcoming period of higher power demand in the power system, and
wherein the EV charging scheduling information includes scheduling of charging of EVs outside of the target time period to curtail the aggregate charging load of the EVs during the target time period.

20. The non-transitory computer-readable medium according to claim 17, wherein the charging curtailment prediction information comprises information relating to at least one of:
a prediction of an aggregate number of EVs that will be available during the target time period to have their charging curtailed; and
a prediction of an aggregate amount of EV charging load that will be available during the target time period to be curtailed.
